(19) United States
(12) Patent Application Publication
(10) Pub. No.: US 2021/0078146 A1
(43) Pub. Date: Mar. 18, 2021

(54) ELECTRIC WORK MACHINE

(71) Applicant: MAKITA CORPORATION, Anjo-Shi (JP)

(72) Inventors: Yuta ARAKI, Anjo-Shi (JP); Akira ITO, Anjo·shi (JP)

(21) Appl. No.: 17/015,812

(22) Filed: Sep. 9, 2020

(30) Foreign Application Priority Data
Sep. 13, 2019 (JP) 2019-167699

(51) Int. Cl. B25B 23/147; B25F 5/00; H02K 7/14; B25F 5/02

(52) U.S. Cl. CPC B25B 23/147; B25F 5/02; H02K 7/145; B25F 5/001

(57) ABSTRACT

An electric work machine (1A; 1B; 1C; 1D), such as a power tool or outdoor power equipment, includes: a motor (6; 6B; 6C; 6D); an output shaft (8A; 8B; 8C; 8D) driven using power (rotational motion) output by the motor; a dial (16) configured to rotate 360° or more around a dial axis (DX); a rotation sensor (56) configured to detect rotation of the dial; and a controller (17). The controller (17) comprises a setting-instruction part (17F) and/or stored instructions configured to output, based on detection data from the rotation sensor, a setting instruction that sets a drive condition of the motor.

### CROSS-REFERENCE

The present application claims priority to Japanese patent application serial number 2019-167699 filed on Sep. 13, 2019, the contents of which are incorporated fully herein by reference.

### TECHNICAL FIELD

The present disclosure relates to an electric work machine that has, e.g., a dial for setting a drive condition of a motor.

### BACKGROUND ART

US 2013/0327552 discloses a power tool that has a dial for rotating a rotary potentiometer to set a torque threshold. However, by design, rotary potentiometers are rotatable less than 360°, thereby limiting the settable range and/or the resolution of output signals.

### SUMMARY OF THE INVENTION

There is a demand in the art to be able to more finely set one or more drive conditions of a motor in order to improve the functionality of an electric work machine. Consequently, there is a demand for techniques that can finely set, with good ease of operation, one or more drive condition(s) of the motor.

It is therefore one non-limiting object of the present disclosure to provide techniques for finely setting a drive condition of a motor with good ease of operation.

In one aspect of the present disclosure, an electric work machine, such as a power tool (such as a handheld power tool), comprises: a motor; an output shaft, which is driven based on (using) power (e.g., motive power) transmitted from (generated by) the motor; a dial, which is rotatable 360° or more (i.e. at least 360°) around a dial axis; a rotation sensor, which detects rotation of the dial; and a controller that comprises a setting-instruction part (e.g., a hardware part and/or software code) that outputs, based at least in part on detection data of (from, generated by) the rotation sensor, a setting instruction that sets a drive condition of the motor.

According to this aspect of the present disclosure, at least one drive condition of the motor can be easily set (i.e. with good ease of operation).

Additional aspects, embodiments, features, effects and advantages of the present teachings will become apparent to a person skilled in the art upon reading the following detailed description in view of the appended claims and drawings.

### BRIEF DESCRIPTION OF THE DRAWINGS

FIG. 1 is an oblique view, viewed from the front, that shows a power tool according to a first embodiment of the present teachings.

FIG. 2 is an oblique view, viewed from the rear, that shows the power tool according to the first embodiment.

FIG. 3 is a side view that shows the power tool according to the first embodiment.

FIG. 4 is a cross-sectional view that shows the power tool according to the first embodiment.

FIG. 5 is a partial, cross-sectional view of the power tool according to the first embodiment.

FIG. 6 is a cross-sectional view that shows a dial according to the first embodiment.

FIG. 7 is an exploded, oblique view that shows the dial according to the first embodiment.

FIG. 8 is a cross-sectional view that shows the dial according to the first embodiment.

FIG. 9 is a cross-sectional view that shows the dial according to the first embodiment.

FIGS. 10A-10D are schematic drawings that show the operation of a permanent magnet and a rotation sensor according to the first embodiment.

FIG. 11 shows an interface panel according to the first embodiment.

FIG. 12 is a functional block diagram that shows a controller according to the first embodiment.

FIG. 13 shows a flow chart that describes the operation of a power tool according to the first embodiment.

FIG. 14 is an oblique view, viewed from the rear, that shows the power tool according to a modified example of the first embodiment.

FIG. 15 is an oblique view, viewed from the front, that shows the power tool according to another modified example of the first embodiment.

FIG. 16 is an oblique view, viewed from the rear, that shows the power tool according to another modified example of the first embodiment.

FIG. 17 is an oblique view, viewed from the rear, that shows the power tool according to another modified example of the first embodiment.

FIG. 18 is an oblique view, viewed from the front, that shows a power tool according to a second embodiment.

FIG. 19 is an oblique view, viewed from the rear, that shows the power tool according to the second embodiment.

FIG. 20 is a side view that shows the power tool according to the second embodiment of the present teachings.

FIG. 21 is a cross-sectional view that shows the power tool according to the second embodiment.

FIG. 22 is an oblique view, viewed from the rear, that shows the power tool according to a modified example of the second embodiment.

FIG. 23 is an oblique view, viewed from the rear, that shows the power tool according to another modified example of the second embodiment.

FIG. 24 is an oblique view, viewed from the front, that shows a power tool according to a third embodiment of the present teachings.

FIG. 25 is an oblique view, viewed from the rear, that shows the power tool according to the third embodiment.

FIG. 26 is a side view that shows the power tool according to the third embodiment.

FIG. 27 is a cross-sectional view that shows the power tool according to the third embodiment.

FIG. 28 is an oblique view, viewed from the front, that shows the power tool according to a modified example of the third embodiment.

FIG. 29 is an oblique view, viewed from the front, that shows the power tool according to another modified example of the third embodiment.

FIG. 30 is an oblique view, viewed from the front, that shows a power tool according to a fourth embodiment of the present teachings.

FIG. 31 is an oblique view, viewed from the rear, that shows the power tool according to the fourth embodiment.

FIG. 32 is a side view that shows the power tool according to the fourth embodiment.

FIG. 33 is a cross-sectional view that shows the power tool according to the fourth embodiment.

FIG. 34 is an oblique view, viewed from the front, that shows the power tool according to a modified example of the fourth embodiment.

### DETAILED DESCRIPTION OF EMBODIMENTS OF THE PRESENT TEACHINGS

Exemplary embodiments according to the present disclosure are explained below, with reference to the drawings, but the present disclosure is not limited thereto. Structural elements in the embodiments explained below can be combined where appropriate. In addition, some of the structural elements may be omitted in further embodiments of the present teachings.

In the embodiments described below, the positional relationships among parts are explained using the terms left, right, front, rear, up, and down. These terms indicate relative positions and directions, using the center of an electric work machine as a reference. In the embodiments described below, the electric work machine is, in each case, a power tool comprising a motor.

In the embodiments described below, the direction parallel to rotational axis AX of the motor is called the axial direction where appropriate, the direction that goes around rotational axis AX is called the circumferential direction or the rotational direction where appropriate, and the directions radially extending (perpendicular) to rotational axis AX are called the radial direction where appropriate.

In the embodiments described below, rotational axis AX extends in the front-rear direction. The axial direction and the front-rear direction coincide or are parallel. One side in the axial direction is forward, and the other side in the axial direction is rearward. In addition, in the radial direction, a location that is close to rotational axis AX or a direction that approaches rotational axis AX is called inward in the radial direction where appropriate, and a location that is far from rotational axis AX or a direction that leads away from rotational axis AX is called outward in the radial direction where appropriate.

### First Embodiment

### Overview of Power Tool

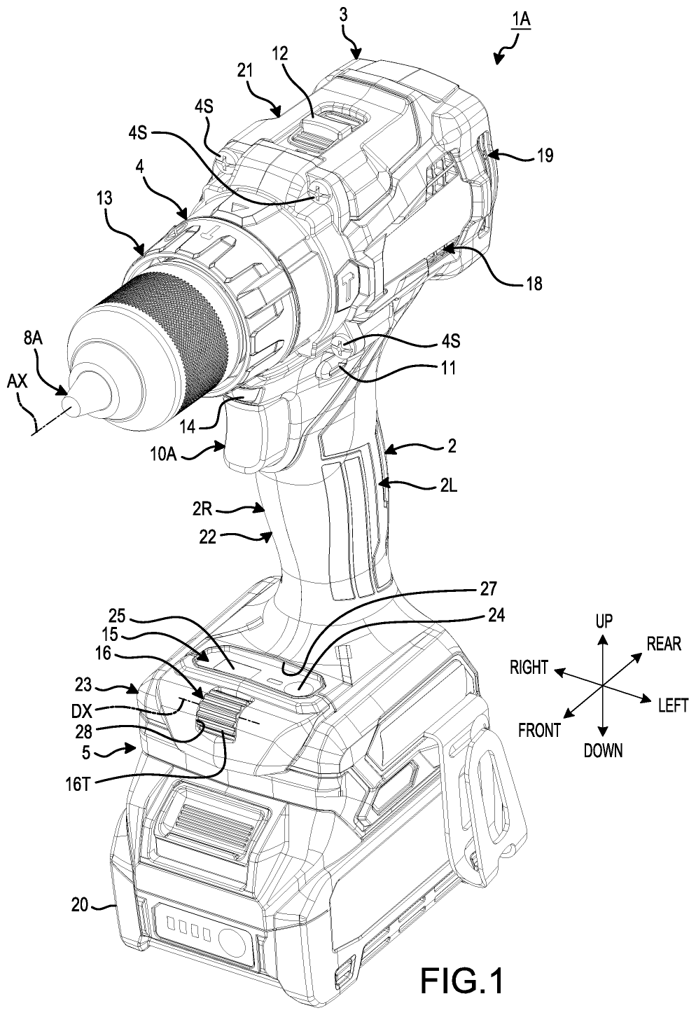

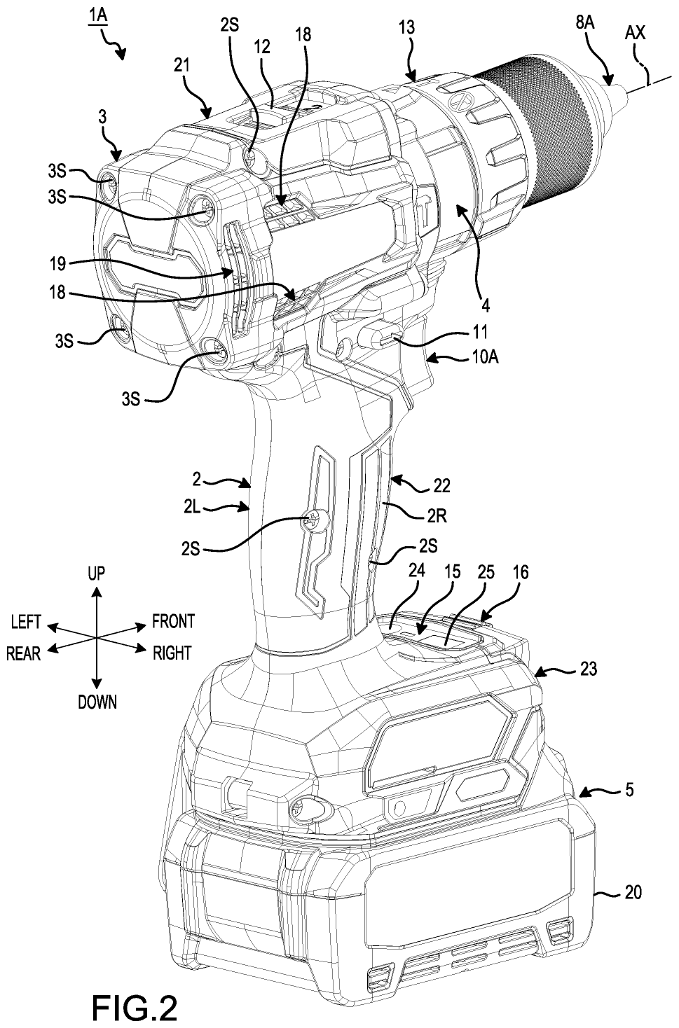

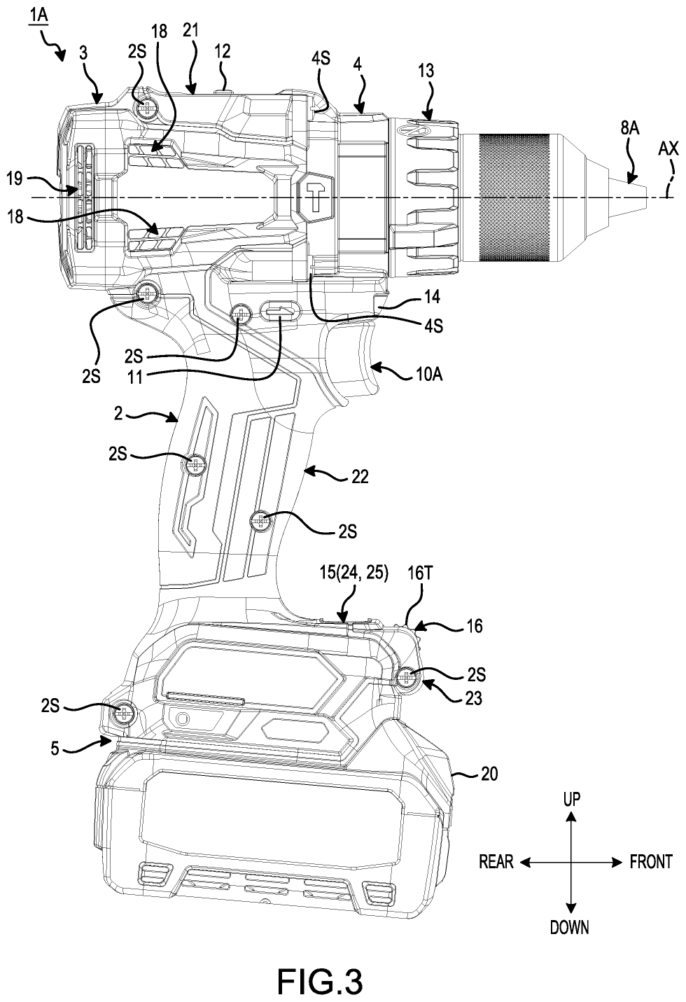

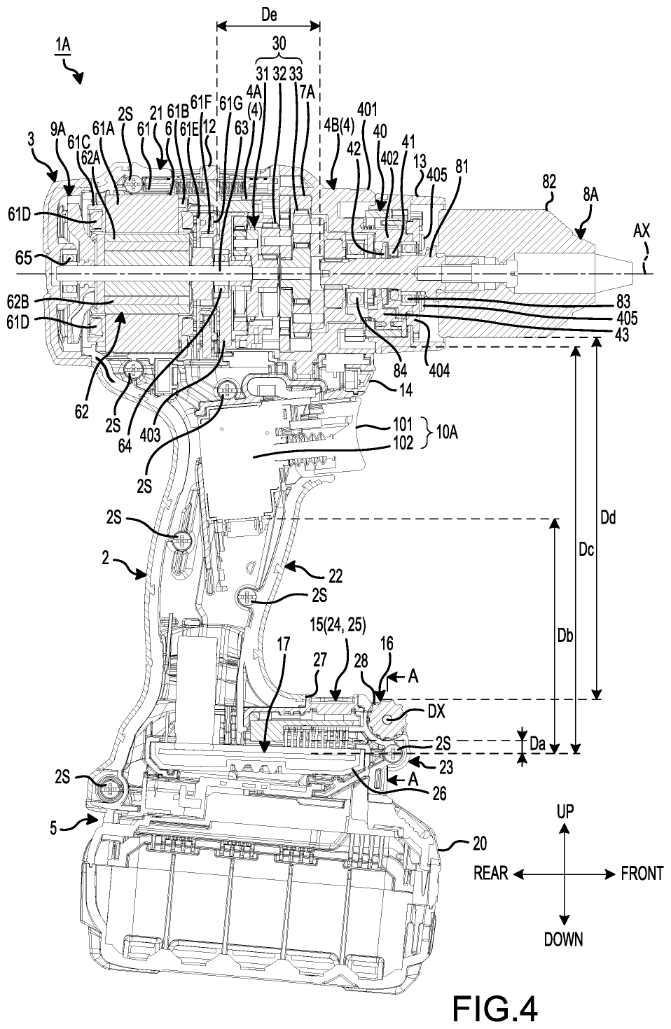

FIG. 1 is an oblique view, viewed from the front, that shows a power tool 1A according to the present (first) embodiment. FIG. 2 is an oblique view, viewed from the rear, that shows the power tool 1A according to the present embodiment. FIG. 3 is a side view that shows the power tool 1A according to the present embodiment. FIG. 4 is a cross-sectional view that shows the power tool 1A according to the present embodiment. In the present embodiment, the power tool 1A is a hammer driver-drill.

As shown in FIGS. 1-4, the power tool 1A comprises a housing 2, a rear cover 3, a casing 4, a battery-mounting part 5, a motor 6, a power-transmission mechanism 7A, an output shaft 8A, a fan 9A, a trigger switch 10A, a forward/reverse change lever (reversing switch lever) 11, a speed change lever 12, a mode-changing ring (action mode changing ring) 13, a light 14, an interface panel 15, a dial 16, and a controller (controlling means) 17.

The housing 2 is made of synthetic resin, i.e. a rigid polymer, such as nylon (polyamide). The housing 2 comprises a left housing 2L and a right housing 2R that are fixed to one another by screws 2S. When the left housing 2L and the right housing 2R are fixed to one another, the housing 2 is formed.

The housing 2 comprises a motor-housing part (portion) 21, a grip part (grip or handle) 22, and a controller-housing part (portion) 23.

The motor-housing part 21 houses the motor 6 and has a tube shape.

The grip part 22 is configured to be gripped by a user. The grip part 22 is disposed downward of the motor-housing part 21 and protrudes downward from the motor-housing part 21. The trigger switch 10A is disposed on the grip part 22.

The controller-housing part 23 houses the controller 17 and is disposed downward of the grip part 22. The controller-housing part 23 is connected to a lower-end portion of the grip part 22. The dimensions of the outer shape of the controller-housing part 23 in both the front-rear direction and the left-right direction are larger than the dimensions of the outer shape of the grip part 22.

The rear cover 3 is made of synthetic resin, i.e. a rigid polymer, such as nylon (polyamide). The rear cover 3 is disposed rearward of the motor-housing part 21 and houses the fan 9A. The rear cover 3 is disposed such that it covers an opening in a rear portion of the motor-housing part 21. The rear cover 3 is fixed to the motor-housing part 21 by screws 3S.

The motor-housing part 21 has air-suction ports 18 and the rear cover 3 has air-exhaust ports 19. Air outside of the housing 2 flows into the interior space of the housing 2 via the air-suction ports 18. Air in the interior space of the housing 2 flows out of the housing 2 via the air-exhaust ports 19.

The casing 4 houses the power-transmission mechanism 7A and comprises a first casing 4A and a second casing 4B. The second casing 4B is disposed forward of the first casing 4A. The mode-changing ring 13 is disposed forward of the second casing 4B. The first casing 4A is made of synthetic resin, i.e. a rigid polymer, such as nylon (polyamide). The second casing 4B is made of metal, such as aluminum or an aluminum alloy. The casing 4 is disposed forward of the motor-housing part 21. The first casing 4A and the second casing 4B each have a tube shape.

The second casing 4B comprises a large-diameter part (portion) 401 and a small-diameter part (portion) 402. At least a portion of the small-diameter part 402 is disposed inward of the large-diameter part 401 in the radial direction. A front-end portion of the small-diameter part 402 is disposed forward of a front-end portion of the large-diameter part 401. The first casing 4A is fixed to a rear-end portion of the large-diameter part 401. An opening in the rear-end portion of the first casing 4A is covered by a bracket plate 403. An opening in a front-end portion of the second casing 4B is covered by a stop plate 404. The stop plate 404 is fixed to the front-end portion of the small-diameter part 402 by screws 405.

The casing 4 is disposed such that it covers an opening in a front portion of the motor-housing part 21. The first casing 4A is disposed inward of the motor-housing part 21. The second casing 4B is fixed to the motor-housing part 21 by screws 4S.

The battery-mounting part 5 is formed on (at) a lower portion of the controller-housing part 23. The battery-mounting part 5 is configured to be detachably connected to a battery pack (battery cartridge) 20. That is, the battery pack 20 is mountable on the battery-mounting part 5 in a detachable manner. For example, the battery-mounting part 5 preferably includes structures (means) for electrically connecting to the battery pack 20, such as battery-connection (power) terminals and one or more signal communication terminals, and structures (means) for physically connecting to the battery pack 20, such as slide rails, as is well known in the art. The battery pack 20 includes one or more secondary (rechargeable) battery cells. In the present embodiment, the battery pack 20 includes one or more rechargeable lithium-ion battery cells. When mounted on the battery-mounting part 5, the battery pack 20 can supply electric power (direct current) to the power tool 1A. The motor 6 generates a driving force (in particular, a rotational driving force in the present embodiment) based upon (using) the electric power supplied from the battery pack 20. The interface panel 15 and the controller 17 also operate based upon (using) the electric power supplied from the battery pack 20.

The motor 6 is the source of motive power for the power tool 1A. The motor 6 is preferably an inner-rotor-type brushless motor, although the present teachings are also applicable to outer-rotor type motors. As was noted above, the motor 6 is housed in the motor-housing part 21. The motor 6 comprises a stator 61, which has a tube shape, and a rotor 62, which is disposed inward of the stator 61. The rotor 62 comprises a rotor shaft (rotary shaft) 63, which extends in the axial direction.

The power-transmission mechanism 7A is disposed forward of the motor 6 and is housed in the casing 4. The power-transmission mechanism 7A operably couples the rotor shaft 63 to a spindle 81, which is part of the output shaft 8A. Therefore, the power-transmission mechanism 7A transmits the power, which the motor 6 has generated, to the output shaft 8A.

The power-transmission mechanism 7A comprises a speed-reducing (torque-increasing) mechanism (gear transmission or gear train) 30 and a hammer mechanism 40. The speed-reducing mechanism 30 preferably comprises a plurality of gears and in certain embodiments of the present teachings, the speed-reducing mechanism 30 may comprise two or more stages of gears so that a high-speed mode and a low-speed mode may be set (implemented), as will be further described below.

The speed-reducing mechanism 30 receives the rotational output of the rotor shaft 63 and causes the output shaft 8A to rotate at a rotational speed that is lower than the rotational speed of the rotor shaft 63. That is, the speed-reducing mechanism 30 is configured to provide a mechanical advantage, whereby the torque output by the motor 6 is amplified (increased) so that the torque applied to the spindle 81 (and thus to the output shaft 8A) is greater than the torque output by the motor 6. In the present embodiment, the speed-reducing mechanism 30 comprises a first (first stage) planetary-gear mechanism 31, a second (second stage) planetary-gear mechanism 32, and a third (third stage) planetary-gear mechanism 33. The second planetary-gear mechanism 32 is disposed forward of the first planetary-gear mechanism 31. The third planetary-gear mechanism 33 is disposed forward of the second planetary-gear mechanism 32.

The hammer mechanism 40 causes the output shaft 8A to hammer in the axial direction. That is, when actuated, the hammer mechanism 40 generates a percussive force (i.e. a rapid succession of short hammer thrusts) on the output shaft 8A. The hammer mechanism 40 comprises a first cam 41, a second cam 42, and a hammer-switching ring 43.

When a tool accessory is mounted on and/or in the output shaft 8A, the output shaft 8A drives the tool accessory using the power (rotational driving force) transmitted from the motor 6 via the power-transmission mechanism 7A. The output shaft 8A comprises the spindle 81, which rotates around rotational axis AX using the power transmitted from the motor 6, and a chuck 82, on (in) which the tool accessory is mounted.

The fan 9A is disposed rearward of the motor 6 and generates an airflow to cool the motor 6. The fan 9A is fixed to at least a portion of the rotor 62, e.g., to a rear portion of the rotor shaft 63. The fan 9A rotates owing to the rotation of the rotor shaft 63 such that the fan 9A rotates together with the rotor shaft 63. Owing to the rotation of the fan 9A, air from outside of the housing 2 flows into the interior space of the housing 2 via the air-suction ports 18. This air cools the motor 6 by circulating through the interior space of the housing 2. Thereafter, the heated air flows out of the housing 2 via the air-exhaust ports 19.

The trigger switch 10A is configured to be manually manipulated by the user to start and stop the motor 6 and also to determine the rotational speed of the motor 6. Generally speaking, the greater the amount of depression (pulling) of the trigger switch 10A, the higher the rotational speed of the motor 6. The trigger switch 10A is disposed on the grip part 22. The trigger switch 10A comprises a trigger member 101 and a switch circuit 102. The switch circuit 102 is housed in the grip part 22. The trigger member 101 protrudes forward from an upper portion of a front portion of the grip part 22. When the user releases the trigger member 101, the driving of the motor 6 is stopped.

The forward/reverse change lever 11 is provided on the upper portion of the grip part 22 and is configured to be manually manipulated by the user. When the forward/reverse change lever 11 is pushed (e.g., laterally—in the left-right direction), the rotational direction of the motor 6 is switched from one of a forward-rotational direction and a reverse-rotational direction to the other of the forward-rotational direction and the reverse-rotational direction, and vice versa. When the rotational direction of the motor 6 is switched, the rotational direction of the spindle 81 also is switched.

The speed change lever 12 is provided on an upper portion of the motor-housing part 21 and is also configured to be manipulated by the user. More specifically, the operating state (effective gear ratio or mechanical advantage) of the speed-reducing mechanism 30 is changeable by manually manipulating (e.g., pushing in the front-rear direction) the speed change lever 12. Thus, when the speed change lever 12 is manipulated, a speed mode (e.g., high-speed mode or low-speed mode) of the speed-reducing mechanism 30 is switched. The selected speed mode is one rotational-speed condition of the output shaft 8A according to the present teachings.

More specifically, the speed-reducing mechanism 30 is adapted/configured to be operated in two different operating states (i.e. two different speed modes), namely: the above-mentioned low-speed mode, in which the output shaft 8A is caused to rotate at a first speed (more specifically, the output shaft 8A is rotatable in a first rotational speed range, such as 0-500 rpm), and the above-mentioned high-speed mode, in which the output shaft 8A is caused to rotate at a second speed (more specifically, the output shaft 8A is rotatable in a second rotational speed range, such as 0-2000 rpm) that is higher than the first speed. That is, the second rotational speed range has a maximum rotational speed (e.g., 2000 rpm) that is higher than the maximum rotational speed (e.g., 500 rpm) of the first rotational speed range. Thus, when the speed change lever 12 is manipulated, the speed mode (operating state or effective gear ratio) of the speed-reducing mechanism 30 is switched from one to the other of the low-speed mode and the high-speed mode. The speed-reducing mechanism 30 is adapted/configured to generate higher output torque in the low-speed mode owing to the increased mechanical advantage of the speed-reducing mechanism 30 in the low-speed mode.

The mode-changing ring (action mode changing ring) 13 is disposed forward of the casing 4 and is also configured to be manually manipulated by the user. That is, the user can switch the operating state (action mode) of the hammer mechanism 40 by manipulating (e.g., rotating) the mode-changing ring 13. Thus, when the mode-changing ring 13 is manipulated, the action mode is switched. The selected action mode is one operating condition of the hammer mechanism 40 according to the present teachings.

In principle, the hammer mechanism 40 is configured to be operated in two different types of operating modes (i.e. two different action modes), namely: a hammering mode, in which the output shaft 8A is caused to hammer in the axial direction (i.e. the output shaft 8A rotates while hammering), and a non-hammering mode, in which the output shaft 8A is not caused to hammer in the axial direction (i.e. the output shaft 8A only rotates). Thus, when the mode-changing ring 13 is manipulated (rotated), the action mode of the hammer mechanism 40 is switched from one to the other of the hammering mode and the non-hammering mode. In other words, the mode-changing ring 13 functions as a changing member (switching member) that changes (switches) the action mode of the hammer mechanism 40 between the hammering mode and the non-hammering mode. When the hammer mechanism 40 is switched to the non-hammering mode, two “drive modes” are available, namely a drilling mode and a screwdriving mode (clutch mode) that will be further discussed below. These two “drive modes” may alternately be referred to as additional action modes. However, it is noted that, in alternate embodiments of the present teachings, the mode-changing ring 13 may be adapted/configured to be rotatable to three different rotational positions, which respectively correspond to the hammering mode, the drilling mode and the screwdriving mode. In this case, the action mode may be set directly by the mode-changing ring 13.

The light 14 is provided on the upper portion of the front portion of the grip part 22. The light 14 emits illumination light, which illuminates forward of the power tool 1A. The light 14 includes, for example, one or more light-emitting diodes (LEDs).

The interface panel (operating panel or switch panel) 15 is provided on the controller-housing part 23 and has a generally plate or planar shape. The interface panel 15 comprises at least one manipulation device (e.g., a button) 24 and at least one display device 25.

A panel opening 27 is formed in the controller-housing part 23. The panel opening 27 is formed, forward of the grip part 22, in an upper surface of the controller-housing part 23. At least a portion of the interface panel 15 is disposed in the panel opening 27.

The dial 16 is rotatable around dial axis DX. More specifically, the dial 16 is endlessly rotatable (i.e. more than 360°) around dial axis DX, which extends, e.g., in the left-right direction. In the present embodiment, the dial 16 is disposed on the controller-housing part 23, e.g., on a front portion of the controller-housing part 23.

A dial opening 28 is formed in the controller-housing part 23. The dial opening 28 is formed, forward of the panel opening 27, in the upper surface of the controller-housing part 23. At least a portion of the dial 16 is disposed in the dial opening 28.

The dial 16 is adapted/configured to be manipulated (e.g., manually rotated) by the user to set a first drive condition of the motor 6. In some embodiments of the present teachings (see below), the manipulation device 24 may be adapted/configured to be manipulated (e.g., pressed) to set a second drive condition of the motor 6 that differs from the first drive condition set using the dial 16. In additional or alternative embodiments of the present teachings, the manipulation device 24 may be adapted/configured to be manipulated (e.g., pressed) to turn ON and OFF a torque threshold setting process, as will be explained further below.

For example, in the following description, the first drive condition of the motor 6 set using the dial 16 is called a “drive condition” where appropriate, and the second drive condition of the motor 6, which may be set using the manipulation device 24 (or by the mode-changing ring 13 in alternate embodiments), is called a “drive mode” or “action mode” where appropriate.

For example, in the present (first) embodiment shown in the accompanying figures, after the mode-changing ring 13 has been set (rotated) to the non-hammering mode, the manipulation device 24 is manipulated (e.g., pressed) by the user to set the drive mode of the motor 6 to one of a drilling mode and a screwdriving mode (also known as a “clutch mode”, in particular in power tools that have a mechanical clutch). The “drilling mode” means a drive mode (or action mode) in which the motor 6 generates the driving force regardless of the amount of torque (i.e. the fastening torque) that is momentarily being applied to the output shaft 8A (and thus to the bit, such as a drill bit, mounted in the chuck 82) while driving the motor 6. That is, in the drilling mode, the torque currently being applied to the output shaft 8A is ignored and the motor 6 continues to generate the driving force until the user releases the trigger switch 10A. On the other hand, the “screwdriving mode” means a drive mode (or action mode) in which the motor 6 is stopped when the torque (i.e. the fastening torque) momentarily being applied to the output shaft 8A (and thus to the bit, such as a screwdriver bit or a socket, mounted in the chuck 82) exceeds a (variable, user-set) torque threshold (also known as a clutch-actuation torque). Thus, the screwdriving mode of the present teachings is effected by an “electronic clutch”, which means that the controller 17 is configured to replace the function of a mechanical clutch that is manually adjustable by the user to set the torque threshold (maximum fastening torque or clutch-actuation torque) to be applied during a driving operation. However, as was mentioned above, in an alternate embodiment of the present teachings, the mode-changing ring 13 may be modified so that it is rotatable, in addition to the hammering mode, to two other rotational positions respectively corresponding to the drilling mode and the screwdriving mode (instead of simply a single rotational position corresponding to the non-hammering mode). In such an alternate embodiment (not shown), the manipulation device 24 is preferably adapted/configured to be manipulated (e.g., pressed) by the user to turn ON and OFF the torque threshold setting process. That is, when the mode-changing ring 13 is rotated to the rotational position corresponding to the screwdriving mode and the manipulation device 24 is then manipulated (pressed), the torque threshold setting process becomes operational. Thereafter, when the manipulation device 24 is manipulated (pressed) again or a timer, which was started when the manipulation device 24 was first manipulated (pressed), expires, the torque threshold setting process is terminated, such that rotation of the dial 16 no longer changes the torque threshold that was set during the torque threshold setting process.

As was explained above, the dial 16 is manipulated by the user to set at least one drive condition of the motor 6. The at least one drive condition of the motor 6 set using the dial 16 includes the torque threshold in the present (first) embodiment. More specifically, the dial 16 is manipulated (rotated) to set the torque threshold in the screwdriving mode, which is set using the manipulation device 24 (or using the mode-changing ring 13 in the above-mentioned (not shown) alternate embodiment).

The controller 17 comprises a computer system and outputs control instructions (drive instructions) that control the motor 6. The controller 17 is housed in the controller-housing part 23. The controller 17 comprises one or more circuit boards, on which a plurality of electronic components is mounted. Illustrative examples of the electronic components mounted on the circuit board(s) include: a processor, such as a CPU (central processing unit, microprocessor); nonvolatile memory, such as ROM (read-only memory), and storage; volatile memory, such as RAM (random-access memory); transistors (switches); capacitors; and resistors.

A controller case 26 is disposed in the interior space of the controller-housing part 23. At least a portion of the controller 17 is housed in the controller case 26.

Motor and Power-Transmission Mechanism

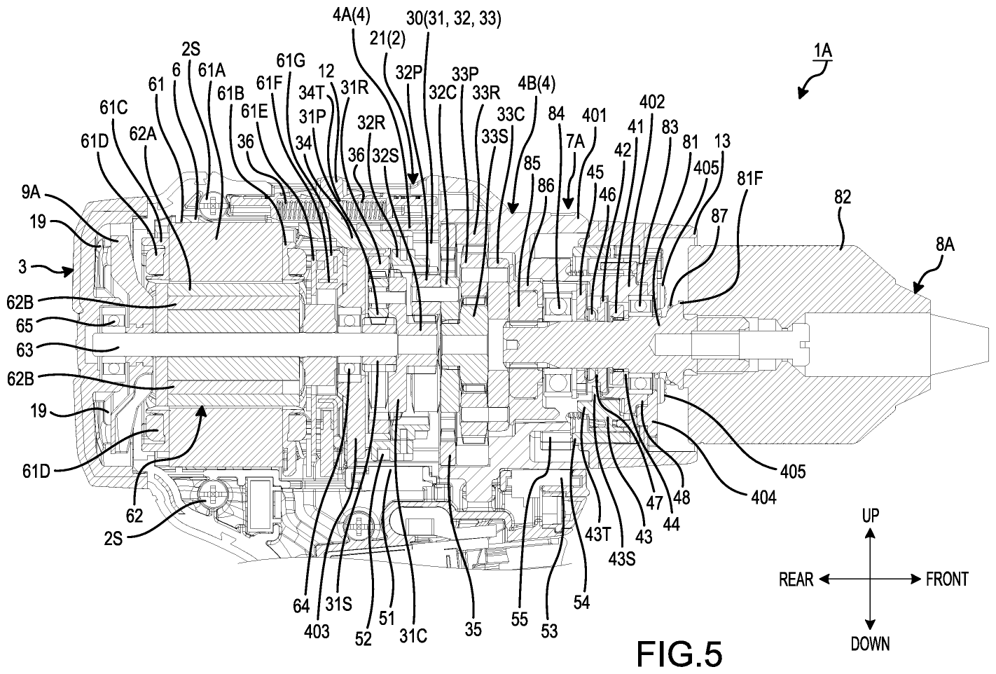

FIG. 5 is a partial, cross-sectional view of the power tool 1A according to the present embodiment. As shown in FIG. 4 and FIG. 5, the motor 6 comprises a stator 61, which has a tube shape, and a rotor 62, which is disposed inward of the stator 61. The rotor 62 comprises the rotor shaft 63, which extends in the axial direction.

The stator 61 comprises: a stator core 61A, which is composed of a plurality of laminated steel plates; a front insulator 61B, which is disposed on a front portion of the stator core 61A; a rear insulator 61C, which is disposed on a rear portion of the stator core 61A; a plurality of coils 61D, the coils 61D being passed around the front insulator 61B and the rear insulator 61C and wound on the stator core 61A; a sensor circuit board 61E, which is mounted on the front insulator 61B; fusing terminals 61F, which are electrically connected to the coils 61D via a winding wire of the coils 61D; and a short-circuiting member 61G, which is supported by the front insulator 61B and is electrically connected to the fusing terminals 61F. The short-circuiting member 61G is connected to the controller 17 via lead wires. Thus, the short-circuiting member 61G electrically connects the controller 17 to the plurality of coils 61D via the fusing terminals 61F. The sensor circuit board 61E comprises a plurality of rotation-detection devices (motor-rotation sensors or motor-speed sensors), which detect the rotation of the rotor 62. The rotation-detection devices (motor-rotation sensors) may be embodied as one or more Hall effect sensors that sense, as the rotor 62 rotates, the varying magnetic fields of end portions of a plurality of permanent magnets 62B mounted on the rotor 62.

The rotor 62 rotates around rotational axis AX. The rotor 62 comprises a rotor core 62A, which has a circular-cylinder shape and is disposed around the rotor shaft 63. The plurality of permanent magnets 62B is held by the rotor core 62A so as to face the coils 61D. More specifically, the rotor core 62A is composed of a plurality of laminated steel plates and has a central through hole, which extends in the axial direction and holds the rotor shaft 63. A plurality of axially-extending through holes also is formed around the circumferential direction of the rotor 62 (i.e. around the central through hole) and the permanent magnets 62B are respectively disposed in the axially-extending through holes of the rotor core 62A.

The rotation-detection devices (motor-rotation sensors or motor-speed sensors) of the sensor circuit board 61E detect the rotation of the rotor 62 by detecting the magnetic fields of the permanent magnets 62B. The controller 17 supplies drive currents to the coils 61D based on, at least in part, detection data of (from, generated by) the rotation-detection devices. This detection data also can be utilized to determine the momentary rotational speed of the motor 6 for use in determining the momentary output torque of the motor 6, as will be further described below.

The rotor shaft 63 rotates around rotational axis AX, which may coincide with the rotational axis of the output shaft 8A. However, in some devices, rotational axis AX of rotor shaft 63 may be offset but parallel to the rotational axis of the output shaft 8A, or may be oblique thereto. A front portion of the rotor shaft 63 is rotatably supported by a first bearing 64. The rear portion of the rotor shaft 63 is rotatably supported by a second bearing 65. The first bearing 64 is held by the bracket plate 403, which is disposed forward of the stator 61. The second bearing 65 is held by the rear cover 3. A front-end portion of the rotor shaft 63 is disposed forward of the first bearing 64. The front-end portion of the rotor shaft 63 is disposed in the interior space of the casing 4.

A pinion gear 31S is provided on (at) the front-end portion of the rotor shaft 63. The rotor shaft 63 is coupled to the first planetary-gear mechanism 31 of the speed-reducing mechanism 30 via the pinion gear 31S.

The first (first stage) planetary-gear mechanism 31 comprises: a plurality of planet gears 31P disposed around the pinion gear 31S; a first carrier 31C, which supports the plurality of planet gears 31P so that they are rotatable relative to the first carrier 31C; and an internal gear (ring gear) 31R, which is disposed around the plurality of planet gears 31P. A gear (i.e. a plurality of gear teeth) is provided on an outer-circumferential portion of the first carrier 31C.

The second (second stage) planetary-gear mechanism 32 comprises: a sun gear 32S; a plurality of planet gears 32P disposed around the sun gear 32S; a second carrier 32C, which supports the plurality of planet gears 32P so that they are rotatable relative to the second carrier 32C; and an internal gear (ring gear) 32R, which is disposed around the plurality of planet gears 32P. The sun gear 32S is disposed forward of the first carrier 31C. The diameter of the sun gear 32S is smaller than the diameter of the first carrier 31C. The first carrier 31C and the sun gear 32S are one body (i.e. integral) and thus the first carrier 31C and the sun gear 32S rotate together.

The third (third stage) planetary-gear mechanism 33 comprises: a sun gear 33S; a plurality of planet gears 33P disposed around the sun gear 33S; a third carrier 33C, which supports the plurality of planet gears 33P so that they are rotatable relative to the third carrier 33C; and an internal gear (ring gear) 33R, which is disposed around the plurality of planet gears 33P. The sun gear 33S is disposed forward of the second carrier 32C.

In addition, the speed-reducing mechanism 30 comprises: a speed-changing ring 34, which is operably coupled to the speed change lever 12, and a coupling ring 35, which is disposed forward of the speed-changing ring 34. The coupling ring 35 is fixed to an inner surface of the first casing 4A. A gear (i.e. a plurality of gear teeth) is provided on an inner-circumferential portion of the coupling ring 35. The speed-changing ring 34 has a protruding part 34T, which protrudes upward. Coil springs 36 are disposed forward and rearward of the protruding part 34T. The speed-changing ring 34 is coupled to the speed change lever 12 via the coil springs 36.

The speed-changing ring 34 is configured to switch the operating state (mechanical advantage or effective gear ratio) of the speed-reducing mechanism 30 between the low-speed mode (the first speed range having a relatively low maximum speed of the output shaft 8A) and the high-speed mode (the second speed range having a relatively high maximum speed of the output shaft 8A). The speed-changing ring 34 is coupled to the internal gear 32R via the speed-changing ring 34. The speed change lever 12, the speed-changing ring 34, and the internal gear 32R are integrally movable as one unit. Therefore, when the speed change lever 12 is manipulated (pushed) by the user, the speed-changing ring 34 moves, within the first casing 4A, in the front-rear direction. The speed-changing ring 34 switches the speed-reducing mechanism 30 between the low-speed mode and the high-speed mode by moving, in the state in which the internal gear 32R and the planet gears 32P are meshed together, in the front-rear direction between a first axial position and a second axial position, which is rearward of the first axial position. Thus, when the speed change lever 12 is manipulated, the speed-reducing mechanism 30 is switched between the low-speed mode operating state and the high-speed mode operating state.

When the internal gear 32R is disposed at the first axial position, the internal gear 32R makes contact with the coupling ring 35. When the internal gear 32R makes contact with the coupling ring 35, rotation of the internal gear 32R relative to the casing 4 is restricted (blocked). On the other hand, when the internal gear 32R is disposed at the second axial position, the internal gear 32R is separated (spaced apart) from the coupling ring 35. When the internal gear 32R is separated from the coupling ring 35, rotation of the internal gear 32R relative to the casing 4 is permitted.

In addition, the internal gear 32R, when it is disposed at the first axial position, meshes with the planet gears 32P. On the other hand, when it is disposed at the axial second position, the internal gear 32R meshes with both the planet gears 32P and the first carrier 31C.

When the rotor shaft 63 is being rotated by the motor 6 while the internal gear 32R is disposed at the first axial position, the pinion gear 31S rotates, and the planet gears 31P revolve around the pinion gear 31S. Owing to the revolving of the planet gears 31P, the first carrier 31C and the sun gear 32S rotate at a rotational speed that is lower than the rotational speed of the rotor shaft 63. When the sun gear 32S rotates, the planet gears 32P revolve around the sun gear 32S. Owing to the revolving of the planet gears 32P, the second carrier 32C and the sun gear 33S rotate at a rotational speed that is lower than the rotational speed of the first carrier 31C. Thus, when the motor 6 generates the rotational driving force while the internal gear 32R is disposed at the first axial position (i.e. in the low-speed mode), the speed-reducing function (torque-increasing function) of the first planetary-gear mechanism 31 and the speed-reducing function (torque-increasing function) of the second planetary-gear mechanism 32 are both utilized, and therefore the second carrier 32C and the sun gear 33S rotate in the low-speed mode, in which higher torque at the output shaft 8A is available.

On the other hand, when the rotor shaft 63 is being rotated by the motor 6 while the internal gear 32R is disposed at the second axial position, the pinion gear 31S rotates, and the planet gears 31P again revolve around the pinion gear 31S. Owing to the revolving of the planet gears 31P, the first carrier 31C and the sun gear 32S rotate at a rotational speed that is lower than the rotational speed of the rotor shaft 63. However, while the internal gear 32R is disposed at the second axial position, because the internal gear 32R meshes with both the planet gears 32P and the first carrier 31C, the internal gear 32R and the first carrier 31C rotate together. Therefore, when the internal gear 32R rotates, the planet gears 32P revolve at a revolving speed that is the same as the rotational speed of the internal gear 32R. This means that the second carrier 32C and the sun gear 33S rotate at a rotational speed that is the same as the rotational speed of the first carrier 31C. Thus, when the motor 6 generates the rotational driving force while the internal gear 32R is disposed at the second axial position (i.e. in the high-speed mode), the speed-reducing function (torque-increasing function) of the first planetary-gear mechanism 31 is utilized (effective) but the speed-reducing function (torque-increasing function) of the second planetary-gear mechanism 32 is not utilized (effective), whereby the second carrier 32C and the sun gear 33S rotate in the high-speed mode. That is, the output shaft 8A can rotate at a higher maximum speed than in the low-speed mode, but a lower maximum torque is available at the output shaft 8A.

When the second carrier 32C and the sun gear 33S rotate, the planet gears 33P revolve around the sun gear 33S. Owing to the revolving of the planet gears 33P, the third carrier 33C rotates.

The spindle 81 is operably coupled to the third carrier 33C via a lock cam 85. More specifically, the spindle 81 is splined to the lock cam 85 and the lock cam 85 is rotatably supported by a lock ring 86. The lock ring 86 is disposed on an inner side of the small-diameter part 402 and is fixed to the small-diameter part 402. Thus, when the third carrier 33C rotates, the spindle 81 rotates.

The spindle 81 is rotatably supported by a third bearing 83 and a fourth bearing 84. The spindle 81 is movable in the front-rear direction in the state in which it is supported by the third bearing 83 and the fourth bearing 84.

The spindle 81 comprises a flange 81F. A coil spring 87 is disposed between the flange 81F and the bearing 83. The coil spring 87 generates an elastic force, which causes the spindle 81 to move forward.

The chuck 82 is configured to chuck (releasably hold) the tool accessory, such as a bit. The chuck 82 is coupled to a front portion of the spindle 81. When the spindle 81 rotates, the chuck 82 rotates the tool accessory.

The first cam 41 and the second cam 42 of the hammer mechanism 40 are disposed on an inner side of the small-diameter part 402. The first cam 41 and the second cam 42 are disposed between the third bearing 83 and the fourth bearing 84 in the front-rear direction.

The first cam 41 has a ring shape and is disposed around the spindle 81. The first cam 41 is fixed to the spindle 81 so that the first cam 41 rotates together (integrally) with the spindle 81. A cam gear is provided on a rear surface of the first cam 41. The first cam 41 is supported by a stop ring 44 that is disposed around the spindle 81. The stop ring 44 is disposed between the first cam 41 and the third bearing 83 in the front-rear direction. Owing to the elastic (biasing) force of the coil spring 87, the stop ring 44 makes contact with a rear surface of the third bearing 83.

The second cam 42 has a ring shape and is disposed rearward of the first cam 41. The second cam 42 is also disposed around the spindle 81. However, the second cam 42 is rotatable relative to the spindle 81. A cam gear is provided on a front surface of the second cam 42 and meshes with the cam gear on the rear surface of the first cam 41. A tab is provided on a rear surface of the second cam 42.

A support ring 45 is disposed between the second cam 42 and the fourth bearing 84 in the front-rear direction. The support ring 45 is disposed on the inner side of the small-diameter part 402 and is fixed to the small-diameter part 402. A plurality of steel balls 46 is disposed on a front surface of the support ring 45. A washer 47 is disposed between the steel balls 46 and the second cam 42. The second cam 42 is rotatable, in the state in which its movement in the front-rear direction is restricted, within the space defined by the small-diameter part 402 and the washer 47.

The hammer-switching ring 43 is configured to switch the operating state of the hammer mechanism 40 between the hammering mode and the non-hammering mode. More specifically, the mode-changing ring 13 is coupled to the hammer-switching ring 43 via a cam ring 48 such that the mode-changing ring 13 and the cam ring 48 are integrally rotatable. Furthermore, the hammer-switching ring 43 is movable in the front-rear direction. The hammer-switching ring 43 has a projection part 43T that is inserted into a guide hole provided in the small-diameter part 402. Therefore, the hammer-switching ring 43 is movable in the front-rear direction while it is being guided in the guide hole provided in the small-diameter part 402. Rotation of the hammer-switching ring 43 is restricted (blocked) by the projection part 43T. When the mode-changing ring 13 is manipulated (rotated) by the user, the hammer-switching ring 43 moves in the front-rear (axial) direction from an advanced position to a retreated position, which is rearward of the advanced position, and vice versa, in order to switch the hammer-switching ring 43 between the hammering mode and the non-hammering mode. Thus, when the mode-changing ring 13 is manipulated (rotated), the operating state of the hammer mechanism 40 is switched between the hammering mode and the non-hammering mode. However, as was noted above, in above-described (not shown) alternate embodiment of the present teachings, the mode-changing ring 13 may be modified so that it is adapted/configured to be rotated to directly set the hammering mode, the drilling mode or the screwdriving mode. In such an alternate embodiment, the manipulation device (button) 24 is not required to be adapted/configured to set the drive mode (action mode).

In the hammering mode, rotation of the second cam 42 is restricted (blocked). On the other hand, in the non-hammering mode (e.g., in the drilling mode or the screwdriving mode), rotation of the second cam 42 is permitted. More specifically, when the hammer-switching ring 43 moves to the advanced position, the rotation of the second cam 42 is restricted. When the hammer-switching ring 43 moves to the retreated position, the rotation of the second cam 42 is permitted.

In the hammering mode, at least a portion of the hammer-switching ring 43, which has moved to the advanced position, makes contact with the second cam 42. Owing to the contact between the hammer-switching ring 43 and the second cam 42, rotation of the second cam 42 is restricted. When the motor 6 generates the driving force while rotation of the second cam 42 is restricted, the first cam 41, which is fixed to the spindle 81, rotates while striking the cam gear of the second cam 42. Consequently, the spindle 81 rotates while hammering in the front-rear direction.

In the non-hammering mode (i.e. the drilling mode or the screwdriving mode), the hammer-switching ring 43, which has moved to the retreated position, is spaced apart (separated) from the second cam 42. When the hammer-switching ring 43 and the second cam 42 are spaced apart from one another, rotation of the second cam 42 is permitted. Therefore, when the motor 6 generates the driving force while rotation of the second cam 42 is permitted, the second cam 42 rotates together (integrally) with the first cam 41 and the spindle 81. Consequently, the spindle 81 rotates without hammering in the front-rear direction.

The hammer-switching ring 43 is disposed around the first cam 41 and the second cam 42. In addition, the hammer-switching ring 43 comprises an opposing part 43S, which opposes a rear surface of the second cam 42. The opposing part 43S protrudes inward in the radial direction from a rear portion of the hammer-switching ring 43.

When the mode-changing ring 13 is manipulated (rotated) and thereby causes the hammer-switching ring 43 to move to the advanced position, the tab on the rear surface of the second cam 42 and the opposing part 43S of the hammer-switching ring 43 make contact with one another. Thereby, rotation of the second cam 42 is restricted. Thus, when the mode-changing ring 13 is manipulated and the hammer-switching ring 43 moves to the advanced position, the hammer mechanism 40 is switched to the hammering mode.

When the mode-changing ring 13 is manipulated (rotated) and thereby causes the hammer-switching ring 43 to move to the retreated position, the opposing part 43S of the hammer-switching ring 43 separates (becomes spaced apart) from the second cam 42. Thereby, rotation of the second cam 42 is permitted. Thus, when the mode-changing ring 13 is manipulated and the hammer-switching ring 43 moves to the retreated position, the hammer mechanism 40 is switched to the non-hammering mode.

Manipulation-State Sensors

The power tool 1A comprises a speed-manipulation-state sensor 51, which detects the manipulation state (position) of the speed change lever 12 to determine whether the speed-changing mechanism 30 has been set to the high-speed mode or the low-speed mode.

In the present embodiment, a permanent magnet 52 is provided on the speed-changing ring 34. The permanent magnet 52 is preferably embedded in the speed-changing ring 34.

The speed-manipulation-state sensor 51 includes a magnetic sensor such as a Hall-effect device (Hall effect sensor). The speed-manipulation-state sensor 51 is disposed downward of the speed-changing ring 34.

When the speed change lever 12 is manipulated (shifted), the permanent magnet 52 moves, in the front-rear direction, together with the speed change lever 12 and the speed-changing ring 34. The speed-manipulation-state sensor 51 detects a change in the magnetic field of the permanent magnet 52 owing to the movement of the permanent magnet 52 relative to the speed-manipulation-state sensor 51. The detection data of (from, generated by) the speed-manipulation-state sensor 51 is output to the controller 17. Therefore, the controller 17 detects the position of the speed change lever 12 based on the detection data from the speed-manipulation-state sensor 51. Consequently, the controller 17 can determine, based on the detection data from the speed-manipulation-state sensor 51, whether the speed-reducing mechanism 30 is set to the high-speed mode or is set to the low-speed mode. In other words, information concerning the current operating state (i.e. the effective gear ratio) of the speed-reducing mechanism 30 can be input into the controller 17, e.g., for use in calculating the momentary torque being applied to the output shaft 8A and determining whether a user-set torque threshold has been reached in the screwdriving mode, as will be further discussed below.

The power tool 1A also comprises a mode-manipulation-state sensor 53, which detects the manipulation state (rotational or angular position) of the mode-changing ring 13. As was described above, in the first embodiment shown in the figures, the mode-changing ring 13 is adapted/configured to be rotated to two different rotational positions, namely a hammering mode position (as indicated by the hammer on the mode-changing ring 13 in FIGS. 1 and 2) and a non-hammering mode position (as indicated by the symbol next to the hammer on the mode-changing ring 13 in FIGS. 2 and 3). Therefore, in the first embodiment, when the mode-changing ring 13 has been rotated to the non-hammering mode position, the manipulation button 24 is adapted/configured to be manipulated (pressed) to select one of the drilling mode and the screwdriving mode as the drive mode. However, in the above-described (not shown) alternate embodiment of the present teachings, the mode-changing ring 13 may be modified so that it is adapted/configured to be rotated to three different rotational positions to directly set the action mode of the power tool 1A to one of: the hammering mode, the screwdriving mode or the drilling mode.

In the present embodiment, a mode-detection ring 54 is provided and rotates integrally with the mode-changing ring 13. As shown in FIG. 5, the mode-detection ring 54 is disposed inward of the mode-changing ring 13 and a permanent magnet 55 is provided on the mode-detection ring 54. The permanent magnet 55 is preferably embedded in the mode-detection ring 54.

The mode-manipulation-state sensor 53 includes a magnetic sensor such as a Hall-effect device (Hall effect sensor). The mode-manipulation-state sensor 53 is disposed downward of the mode-detection ring 54.

When the mode-changing ring 13 is manipulated (rotated) by the user, the permanent magnet 55 rotates together with the mode-changing ring 13 and the mode-detection ring 54. The mode-manipulation-state sensor 53 detects a change in the magnetic field of the permanent magnet 55 that has rotated relative to the mode-manipulation-state sensor 53. The detection data of (from, generated by) the mode-manipulation-state sensor 53 is output to the controller 17. Therefore, the controller 17 detects the position of the mode-changing ring 13 in the rotational direction based on the detection data from the mode-manipulation-state sensor 53. Consequently, the controller 17 can determine, based on the detection data from the mode-manipulation-state sensor 53, whether the hammer mechanism 40 is set to the hammering mode or to the non-hammering mode. However, in the above-described (not shown) alternate embodiment (in which the mode-changing ring 13 is modified to be rotatable to a hammering mode position, a drilling mode position and a screwdriving mode position), the controller 17 can determine, based on the detection data from the mode-manipulation-state sensor 53, which one of the three action modes (i.e. which one of the hammering mode, the drilling mode or the screwdriving mode) has been set by rotating the mode-changing ring 13 to one of the three different rotational positions.

Dial and Dial-Rotation Sensor

As shown in FIGS. 1-4, the dial 16 is disposed in at least a portion of the housing 2. In the present embodiment, the dial 16 is disposed in a defined region of the housing 2 that differs from the grip part 22, in particular on the controller-housing part 23, but the dial 16 may be disposed elsewhere as will be explained below.

At least a portion of the dial 16 is disposed in the dial opening 28, which is formed in the housing 2. In the present embodiment, the dial opening 28 is formed in a front-end portion of the controller-housing part 23.

The dial 16 is disposed forward of the controller 17 and has a tube shape. The dial 16 is configured to be manually manipulated (rotated) by the user. A plurality of protruding parts (ridges) 16T is disposed on a surface of the dial 16 to provide a slip-preventing function. A front portion and an upper portion of the dial 16 are each disposed outward of the surface of the controller-housing part 23.

The dial 16 rotates around dial axis DX, which extends in the left-right direction. As described above, rotational axis AX of the motor 6 extends in the front-rear direction. In the present embodiment, rotational axis AX of the motor 6 is orthogonal to an axis that is parallel to dial axis DX.

As shown in FIG. 4, distance Da between the dial 16 and the controller 17 is shorter than distance Db between the trigger switch 10A and the controller 17.

Distance Da between the dial 16 and the controller 17 is shorter than distance Dc between the motor 6 and the controller 17.

Distance Dd between the dial 16 and the output shaft 8A is longer than distance De between the motor 6 and the output shaft 8A.

Distance Da is the shortest distance between the dial 16 and the controller 17. Distance Db is the shortest distance between the trigger switch 10A and the controller 17. Distance Dc is the shortest distance between the motor 6 and the controller 17. Distance Dd is the shortest distance between the dial 16 and the output shaft 8A. Distance De is the shortest distance between the motor 6 and the output shaft 8A.

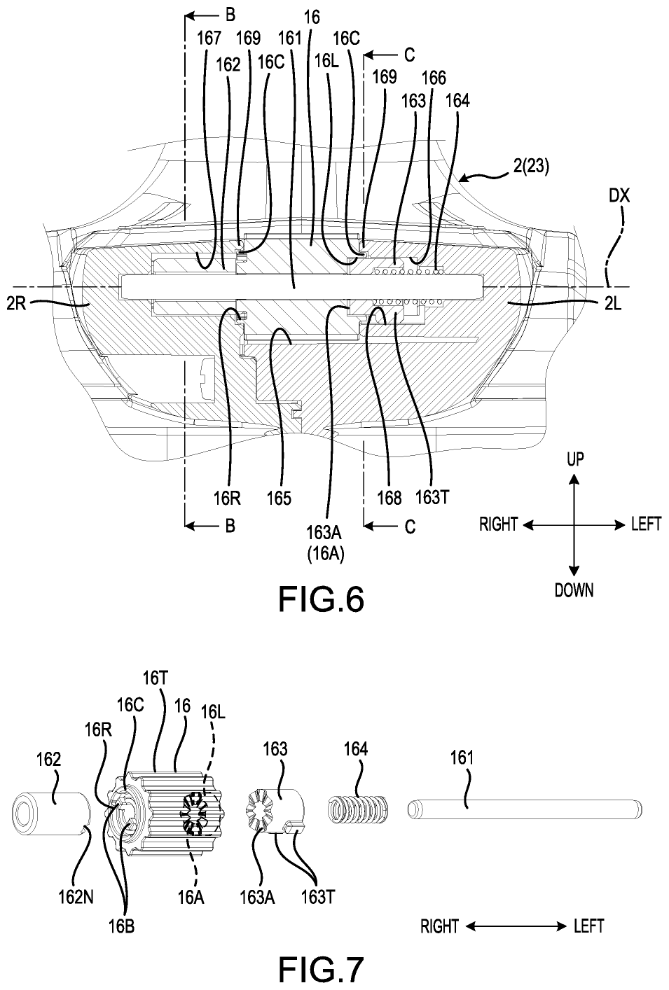

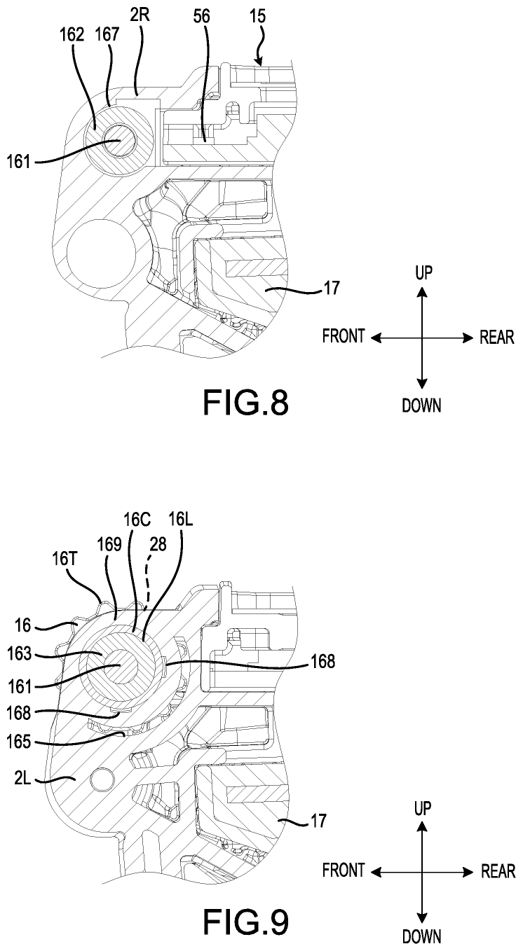

FIG. 6 is a cross-sectional view that shows the dial 16 according to the present embodiment. FIG. 6 corresponds to a cross-sectional auxiliary view taken along line A-A in FIG. 4. FIG. 7 is an exploded, oblique view that shows the dial 16 according to the present embodiment. FIG. 8 and FIG. 9 are cross-sectional views that show the dial 16 according to the present embodiment. FIG. 8 corresponds to a cross-sectional auxiliary view taken along line B-B in FIG. 6. FIG. 9 corresponds to a cross-sectional auxiliary view taken along line C-C in FIG. 6.

As shown in FIGS. 6-9, the power tool 1A comprises: a rod 161, which is disposed inward of the dial 16; a permanent magnet 162, which is supported by the rod 161; a cam 163, which is supported by the rod 161; and a coil spring 164, which is disposed around the rod 161.

The rod 161 is held, forward of the controller 17, by at least a portion of the controller-housing part 23. A left-end portion of the rod 161 is held by the left housing 2L. A right-end portion of the rod 161 is held by the right housing 2R.

The dial 16 is disposed around the rod 161 and is rotatably supported by the rod 161. The dial 16 is endlessly rotatable (i.e. by 360° or more) in both the forward-rotational direction and the reverse-rotational direction around dial axis DX. In other words, there is no restriction on the rotational range of the dial 16.

A recess (left-side recess) 16L is provided on a left surface of the dial 16. A cam projection 16A is provided inward of the recess 16L. A recess (right-side recess) 16R is provided on a right surface of the dial 16. A projection part 16B is provided in the interior of the recess 16R. In addition, ring-shaped protruding parts 16C are provided on the left surface and the right surface of the dial 16.

The permanent magnet 162 rotates together with the dial 16. The permanent magnet 162 is disposed at a location that differs from that of the dial 16 in a direction parallel to dial axis DX, i.e. the permanent magnet 162 is laterally offset from the dial 16 in the left-right direction. In the present embodiment, the permanent magnet 162 is disposed on a right side of the dial 16, although it may be disposed on the left side of the dial 16. The permanent magnet 162 has a tube shape. At least a portion of the rod 161 is disposed in the interior of the permanent magnet 162 such that the permanent magnet 162 is disposed around the rod 161. The permanent magnet 162 is fixed to the dial 16 by, for example, a bonding agent. A notch 162N is formed on a left portion of the permanent magnet 162.

The cam 163 is disposed at a location that differs from that of the dial 16 in a direction parallel to dial axis DX. In the present embodiment, the cam 163 is disposed on a left side of the dial 16. The cam 163 has a tube shape. At least a portion of the rod 161 is disposed in the interior of the cam 163 such that the cam 163 is disposed around the rod 161. The cam 163 is movable in the left-right direction relative to the rod 161. A cam projection 163A is provided on a right surface of the cam 163. Two protruding parts 163T are provided on an outer surface of the cam 163.

The coil spring 164 is disposed at a location that differs from that of the dial 16 in a direction parallel to dial axis DX. In the present embodiment, the coil spring 164 is disposed on the left side of the dial 16. At least a portion of the rod 161 is disposed in the interior of the coil spring 164 so that the coil spring 164 is disposed around the rod 161. At least a portion of the coil spring 164 is disposed inward of the cam 163.

The controller-housing part 23 has: a center recess 165, in which the dial 16 is disposed; a left recess 166, in which the cam 163 is disposed; and a right recess 167, in which the permanent magnet 162 is disposed.

The left-end portion of the rod 161 is held by at least a portion of an inner surface of the left recess 166. The right-end portion of the rod 161 is held by at least a portion of an inner surface of the right recess 167.

The protruding parts 163T of the cam 163 are inserted into grooves 168, which are formed on the inner side of the left recess 166. Thereby, the rotation of the cam 163 is restricted.

A right portion of the cam 163 is inserted into the recess 16L of the dial 16. A right portion of the coil spring 164 is disposed in the interior of the cam 163. A left portion of the coil spring 164 is supported by at least a portion of the inner surface of the left recess 166. Because the coil spring 164 is supported by at least a portion of the inner surface of the left recess 166, rotation of the coil spring 164 is restricted. The coil spring 164 generates an elastic (biasing) force that causes the cam 163 to move rightward.

When the dial 16 is manipulated (rotated) by the user while the cam 163 is pressed against the dial 16 by the coil spring 164, the dial 16 rotates relative to the cam 163. Because the dial 16 rotates while the cam projection 16A and the dial 16 make contact with one another, click sensations are generated during the rotation of the dial 16 so that the user can haptically and/or audibly sense the rotation of the dial 16.

The left portion of the permanent magnet 162 is inserted into the recess 16R of the dial 16 such that the projection part 16B is inserted into the notch 162N. Thereby, rotation of the dial 16 relative to the permanent magnet 162 is restricted (prevented, blocked). Consequently, the permanent magnet 162 rotates together (integrally) with the dial 16.

The ring-shaped protruding parts 16C are provided on the left surface and the right surface of the dial 16. Cover parts 169 are provided on the controller-housing part 23 and cover the protruding parts 16C. Owing to the protruding parts 16C and the cover parts 169, the ingress of foreign matter from the space between the housing 2 and the dial 16 to the interior space of the controller-housing part 23 is curtailed (inhibited).

As shown in FIG. 8, the power tool 1A comprises a rotation sensor (dial-rotation sensor) 56, which detects the rotation of the dial 16. More specifically, the rotation sensor 56 includes a magnetic sensor such as a Hall-effect device (Hall effect sensor). The rotation sensor 56 detects the variations in the magnetic field of the permanent magnet 162 when the permanent magnet rotates relative to the rotation sensor 56. The rotation sensor 56 is disposed rearward of the permanent magnet 162 in the present embodiment, but it may be disposed in a position that is radial to the permanent magnet 162.

When the dial 16 is manipulated (rotated), the permanent magnet 162 rotates together with the dial 16. The rotation sensor 56 detects changes in the magnetic field of the permanent magnet 162 caused by the rotation. The detection data of (from, generated by) the rotation sensor 56 is output to the controller 17. Therefore, the controller 17 can determine the rotational direction and the rotational speed of the dial 16 based on the detection data from the rotation sensor 56.

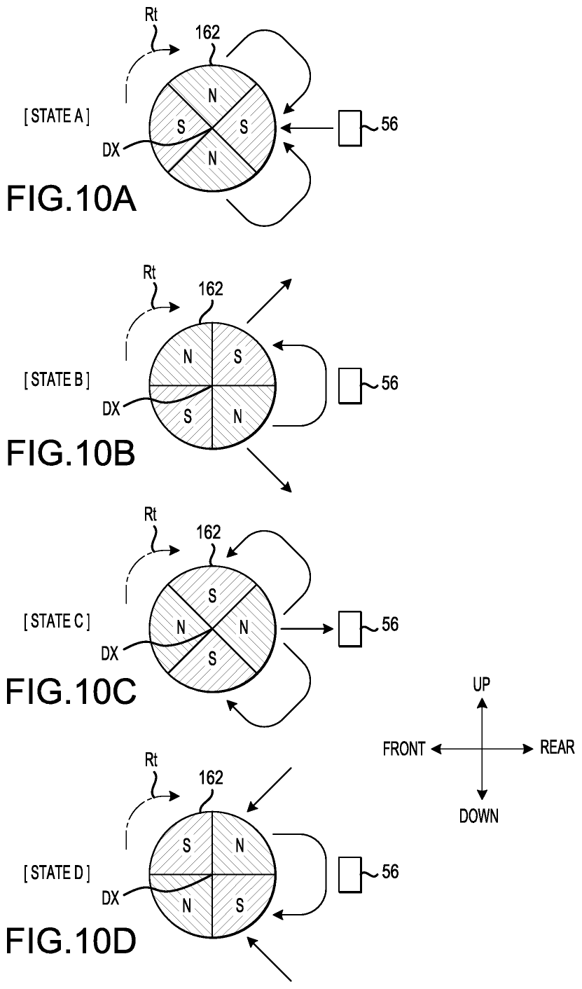

FIGS. 10A-10B are schematic drawings that show the operation of the permanent magnet 162 and the rotation sensor 56 according to the present embodiment. As shown in FIG. 10A, the permanent magnet 162 has differing (alternating) polarities. More specifically, the permanent magnet 162 has N poles and S poles that are disposed in an alternating manner in (around) the circumferential direction of dial axis DX. That is, in the example shown in FIG. 10A, the permanent magnet 162 has two N poles and two S poles that are disposed alternately in the circumferential direction of dial axis DX.

The user can rotate the dial 16 in both the forward-rotational direction and the reverse-rotational direction around dial axis DX. Owing to the rotation of the dial 16, the permanent magnet 162 rotates together with the dial 16. In the example shown in FIG. 10, the rotational direction indicated by arrow Rt will be referred to as the forward-rotational direction.

FIG. 10A shows state A, in which the dial 16 has been rotated such that an S pole and the rotation sensor 56 oppose one another. Therefore, the magnetic-force lines (magnetic field lines) between the permanent magnet 162 and the rotation sensor 56 are directed from the rotation sensor 56 toward the permanent magnet 162.

FIG. 10B shows state B, in which the dial 16 has been rotated such that an N pole and an S pole, which is disposed upward of the N pole, both oppose the rotation sensor 56. Therefore, the magnetic-force lines (magnetic field lines) between the permanent magnet 162 and the rotation sensor 56 are directed from the N pole toward the S pole.

FIG. 10C shows state C, in which the dial 16 has been rotated such an N pole and the rotation sensor 56 oppose one another. Therefore, the magnetic-force lines (magnetic field lines) between the permanent magnet 162 and the rotation sensor 56 are directed from the permanent magnet 162 toward the rotation sensor 56.

FIG. 10D shows state D, in which the dial 16 has been rotated such that an S pole and an N pole, which is disposed upward of the S pole, both oppose the rotation sensor 56. Therefore, the magnetic-force lines (magnetic field lines) between the permanent magnet 162 and the rotation sensor 56 are directed from the N pole toward the S pole.

Thus, the direction in which the magnetic-force lines (magnetic field lines) are directed between the permanent magnet 162 and the rotation sensor 56 changes based on the rotational angle of the dial 16 relative to the rotation sensor 56. That is, the magnetic field between the permanent magnet 162 and the rotation sensor 56 changes based on the rotational angle of the dial 16 relative to the rotation sensor 56. In addition, the magnetic field between the permanent magnet 162 and the rotation sensor 56 changes based on the rotational direction of the dial 16. By detecting the changes in the magnetic field, the rotation sensor 56 can detect both the rotational direction and the rotational angle of the dial 16.

It is noted that, in the embodiment of FIGS. 10A-10D, the permanent magnet 162 has two N poles and two S poles. However, the number of N poles and the number of S poles, which the permanent magnet 162 has, is arbitrary. The number of N poles and the number of S poles should be equal and disposed equispaced in the circumferential direction of dial axis DX. However, the permanent magnet 162 may have one N pole and one S pole or may have three or more N poles and three or more S poles.

Interface Panel

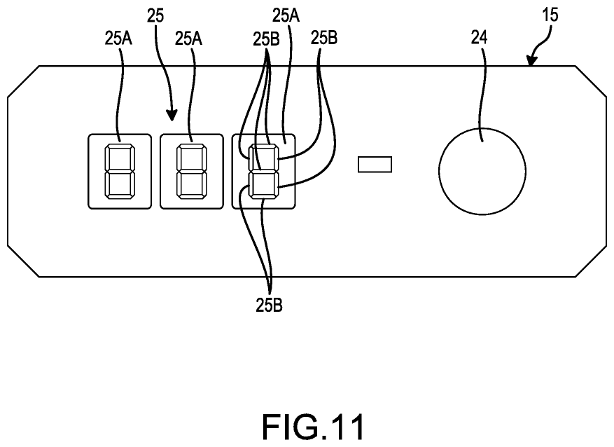

FIG. 11 shows the interface panel (operation-and-display panel) 15 according to the present embodiment, which includes the manipulation device (manipulatable part, button/switch, etc.) 24 and the display device (display part) 25.

The manipulation device 24 may include a manipulatable (pressable) button and a push-button switch that changes its state each time that the user presses the manipulatable button. In the alternative, the manipulation device 24 may be implemented on a touchscreen or may be implemented, e.g., as a toggle switch, a slide switch or a rotary switch. When the mode-changing ring 13 has been rotated to the rotational position for the non-hammering mode, the manipulation device 24 is manipulated (manually operated, e.g., pressed) by the user to set the drive mode of the power tool 1A to one of the drilling mode or the screwdriving mode.

As described above, the mode-changing ring 13 can be manipulated (rotated) to set the action mode (operating state) of the hammer mechanism 40 to either the hammering mode or the non-hammering mode. However, as was noted above, the mode-changing ring 13 may, in (not shown) alternate embodiments, be rotatable to a drilling mode position or a screwdriving mode position, in which case the manipulation device 24 is not manipulated (manually operated, e.g., pressed) by the user to set the drive mode (action mode).

As was mentioned above, when the mode-changing ring 13 is set to the non-hammering mode, it is possible for the user to press the manipulation device 24 to select the drive mode (action mode) as either: the drilling mode, in which the motor 6 is driven to generate the rotational driving force regardless of the torque (fastening torque) that is momentarily being applied to the output shaft 8A while the motor 6 is operating (i.e. the motor 6 is continuously driven until the user releases the trigger switch 10A), or the screwdriving mode (clutch mode), in which the motor 6 is stopped when the torque that is momentarily being applied to the output shaft 8A exceeds the torque threshold (the maximum fastening torque to be applied to a fastener in a fastening operation, which also may be referred to as the “clutch-actuation torque”) that was previously set by the user (or when the user releases the trigger switch 10A, whichever happens first).

Thus, when the hammer mechanism 40 is set to the non-hammering mode using the mode-changing ring 13, the user can manipulate (e.g., press) the manipulation device 24 to set either the drilling mode or the screwdriving mode. When the screwdriving mode is selected, the controller 17 may be adapted/configured (programmed) cause the last set torque threshold (which is stored in memory) to be displayed on the display device (display part) 25 to serve as the starting point for setting a new torque threshold. However, in alternative embodiments, the value displayed on the display device 25 may be set to any value within the settable value range, such as “1” or may be set to an intermediate value within the settable value range. Furthermore, when the screwdriving mode is selected by pressing the manipulation device (button) 24, the controller 17 may be adapted/configured (programmed) to enter a state, in which it inputs and processes data from the rotation sensor 56. Thus, when the user rotates the dial 16 in this state, the data output by the rotation sensor 56 causes the value (number) displayed on the display device (display part) 25 to be incremented or decremented depending on the direction of rotation of the dial 16. When no change in data from the rotation sensor 56 is sensed, a timer may be started in the controller 17. If a time threshold (e.g., 2 seconds, 5 seconds, 10 seconds, etc.) is reached without sensing a change in the data from the rotation sensor 56, the torque threshold sensing process may be terminated, so that further rotation of the dial 16 does not cause the set torque threshold to be changed in an inadvertent manner. To re-start the torque threshold setting process, the user may press the manipulation device (button) 24 again. In addition or in the alternative to the timer, the controller 17 may be adapted/configured (programmed) to terminate the torque threshold setting process when the user presses the manipulation device (button) 24 again, i.e. when the state of the manipulation device (button) 24 changes again.

The display device 25 displays the drive condition of the motor 6. By manipulating (manually rotating) the dial 16, the drive condition of the motor 6 is set. Thus, the display device 25 displays the drive condition (e.g., as a numerical value) of the motor 6 that was set using the dial 16.

In the present embodiment as described above, the drive condition of the motor 6 set using the dial 16 includes the torque threshold in the screwdriving mode. Therefore, the drive condition displayed by the display device 25 is corresponding numerical value of the torque threshold (maximum fastening torque) set by manually rotating the dial 16.

In the present embodiment, the display device 25 comprises a plurality of segmented display devices 25A. In the example shown in FIG. 11, three of the segmented display devices 25A are provided. Each segmented display device 25A comprises a plurality of segmented, light-emitting devices 25B. In the present embodiment, each segmented display device 25A comprises seven of the segmented, light-emitting devices 25B. Each segmented display device 25A can display a numeric character or an alphabetic character by controlling the lamp-ON state and the lamp-OFF state of each of the segmented, light-emitting devices 25B.

It is noted that the display device 25 may instead be a flat-panel display such as a liquid-crystal display, including, e.g., a touchscreen, or may be an indicator-type display device in which multiple light-emitting diodes or other types of light devices are selectively illuminated to indicate the currently-set maximum fastening torque.

The interface panel 15, which comprises the manipulation device 24 and the display device 25, is disposed at least partly surrounding (neighboring) the dial 16. That is, the interface panel 15 is disposed in the vicinity of the dial 16. The interface panel 15 and the dial 16 are preferably adjacent.

As shown in FIGS. 1-4, the interface panel 15 is disposed, rearward of the dial 16, on the controller-housing part 23. Therefore, the user can visually confirm the alphanumeric information displayed on the display device 25 while simultaneously manipulating the dial 16.

Controller

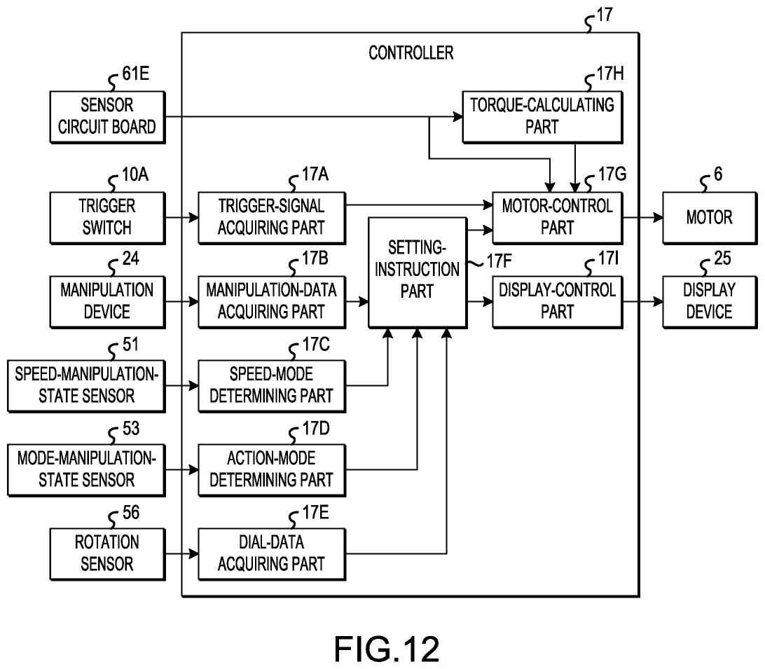

FIG. 12 is a functional block diagram of the controller 17 and the associated components according to the present embodiment. As shown in FIG. 12, the controller 17 is connected to the motor 6, the sensor circuit board 61E, the trigger switch 10A, the manipulation device 24, the display device 25, the speed-manipulation-state sensor (first magnetic sensor that detects whether the speed-changing mechanism 30 is currently in the high-speed operating mode or the low-speed operating mode) 51, the mode-manipulation-state sensor (second magnetic sensor that detects whether the action mode is currently set to the non-hammering mode or the non-hammering mode) 53, and the rotation sensor (third magnetic sensor that detects the rotational direction and angle of the dial 16) 56.

The controller 17 comprises a trigger-signal acquiring part 17A, a manipulation-data acquiring part 17B, a speed-mode determining part 17C, an action-mode determining part 17D, a dial-data acquiring part 17E, a setting-instruction part 17F, a motor-control part 17G, a torque-calculating part 17H, and a display-control part 17I.

The trigger-signal acquiring part 17A acquires a trigger signal from the trigger switch 10A. When the trigger member 101 is manipulated (e.g., depressed), the switch circuit 102 outputs a trigger signal to the trigger-signal acquiring part 17A.

The manipulation-data acquiring part 17B acquires manipulation data of (from, generated by) the manipulation device 24. That is, when the user manipulates (e.g., presses) the manipulation device 24, manipulation data is generated (e.g., a change of state value is generated) and output to the manipulation-data acquiring part 17B. For example, the manipulation data may include the drive mode (the second drive condition of the motor 6) that was manually selected by the user. That is, the selected drive mode may be either the drilling mode or the screwdriving mode. In addition or in the alternative, the manipulation data may include, or may be utilized as, a signal that indicates whether the torque threshold setting process should be initiated and/or terminated.

The speed-mode determining part 17C determines the speed mode, which was set by the user manipulating the speed change lever 12. As was explained above, when the speed change lever 12 is manipulated (e.g., shifted), the speed mode of the speed-reducing mechanism 30 is switched from the low-speed mode to the high-speed mode or vice versa. The speed-mode determining part 17C acquires the detection data of (from, generated by) the speed-manipulation-state sensor 51. The speed-mode determining part 17C then determines, based on the detection data from the speed-manipulation-state sensor 51, whether the speed mode (operating state) of the speed-reducing mechanism 30 is set to the low-speed mode or the high-speed mode.

The action-mode determining part 17D determines the action mode set by the user manipulating the mode-changing ring 13. That is, when the mode-changing ring 13 is manipulated (rotated), the action mode (operating state) of the hammer mechanism 40 is switched between the hammering mode and the non-hammering mode. The action-mode determining part 17D acquires the detection data of (from, generated by) the mode-manipulation-state sensor 53. The action-mode determining part 17D then determines, based on the detection data from the mode-manipulation-state sensor 53, whether the action mode of the hammer mechanism 40 is set to the hammering mode or the non-hammering mode. As was explained above, in a not-shown alternate embodiment of the present teachings, the mode-changing ring 13 optionally may be adapted/configured to be manipulated (rotated) to switch the action mode (operating state) among the hammering mode, the drilling mode and the screwdriving mode.

The dial-data acquiring part 17E acquires dial data that includes the detection data of (from, generated by) the rotation sensor 56. The rotation sensor 56 can detect the rotational direction and the rotational angle of the dial 16 by detecting the changing magnetic fields caused by the permanent magnet 162 of the dial 16 rotating relative to the rotation sensor 56. The rotation sensor 56 outputs the detection data to the dial-data acquiring part 17E. The dial-data acquiring part 17E then calculates, based on the detection data from the rotation sensor 56, the rotational direction and the rotational angle of the dial 16.

The setting-instruction part 17F outputs, based on the dial data that includes the detection data from the rotation sensor 56, a setting instruction that sets the drive condition of the motor 6, i.e. the torque threshold in the present (first) embodiment. The dial data includes the rotational direction and the rotational angle of the dial 16 calculated by the dial-data acquiring part 17E. The setting-instruction part 17F outputs a setting instruction based on the rotational direction and the rotational angle of the dial 16. That is, the setting-instruction part 17F is preferably configured to increment or decrement the torque threshold in accordance with the amount and direction of rotation of the dial 16.

In the present embodiment, the drive condition of the motor 6 includes the torque threshold in the screwdriving mode. That is, when the screwdriving mode has been set using the manipulation device 24 (or using the mode-changing ring 13 in the above-described (not shown) alternate embodiment of the present teachings), the setting-instruction part 17F outputs, based on the dial data, a setting instruction that sets the torque threshold for stopping the drive of the motor 6 (i.e. so that the maximum fastening torque is not exceeded).

The setting-instruction part 17F is also adapted/configured to determine, based on manipulation data of (from, generated by) the manipulation device 24 acquired by the manipulation-data acquiring part 17B, whether the user has set (selected) either the drilling mode or the screwdriving mode. When the setting-instruction part 17F has determined, based on the manipulation data of the manipulation device 24 acquired by the manipulation-data acquiring part 17B, that the screwdriving mode has been set, the setting-instruction part 17F outputs, based on the dial data acquired by the dial-data acquiring part 17E, a setting instruction that sets the torque threshold.

As was explained above, when the user has manipulated (rotated) the mode-changing ring 13 of the present (first) embodiment such that the hammer mechanism 40 is set to the non-hammering mode, the user can then manipulate (e.g., press) the manipulation device 24 to select either the drilling mode or the screwdriving mode as the drive mode.

As was explained above, in the screwdriving mode, the motor 6 is stopped (i.e. the current supply to the motor 6 is stopped) when the torque that is momentarily being applied the output shaft 8A while the motor 6 is operating meets or exceeds the torque threshold that was set by the user by manually rotating the dial 16. Thus, when the user has selected the screwdriving mode, the user can manipulate the dial 16 to set the desired torque threshold (fastening torque) for the next driver (fastener) operation.

Owing to the design of the dial 16 according to the present teachings, the torque threshold can be set finely. As one example, in the present embodiment, the setting-instruction part 17F can set the torque threshold in 40 steps. When the dial 16 is rotated 45° in the forward-rotational direction, the torque threshold is incremented by one step. When the dial 16 is rotated 45° in the reverse-rotational direction, the torque threshold is decremented by one step. In the present embodiment, the dial 16 is rotatable 360° or more (i.e. endlessly or limitlessly rotatable) in both the forward-rotational direction and the reverse-rotational direction around dial axis DX. Consequently, the user can finely set the torque threshold in 40 steps by rotating the dial 16 45° per step in the forward-rotational direction or the reverse-rotational direction. In other words, to change the torque threshold from the first step (lowest torque threshold) to the fortieth step (highest torque threshold), five complete revolutions of the dial 16 of the present embodiment are required. This means that the rotational angle between steps can be made greater than known dials that use a rotary potentiometer, which is limited to rotating less than 360°. Owing to the greater rotational angle between steps, higher resolution can be achieved in the torque setting process, thereby enabling the torque threshold to be set more finely than in known embodiments using, e.g., a rotary potentiometer.

It is noted that the number of steps of the torque threshold does not have to be 40 steps and may be fewer than 40 steps or greater than 40 steps. In addition, the rotational angle of the dial 16 for changing the torque threshold by one step does not have to be 45° and may be less than 45° or more than 45°.

As was explained above, when the drilling mode has been selected using the manipulation device 24, the setting-instruction part 17F does not set a torque threshold. Therefore, the motor 6 will continue to rotate in the drilling mode until the user releases the trigger switch 10A.

The motor-control part 17G outputs control instructions to control the operation (drive) of the motor 6. The control instructions of the motor 6 include at least a drive instruction to drive the motor 6 and a stop instruction to stop the motor 6. When the motor-control part 17G determines, based on a trigger signal acquired by the trigger-signal acquiring part 17A, that the trigger member 101 has been manipulated (depressed), the motor-control part 17G outputs a drive instruction to drive the motor 6. The motor-control part 17G can control (change) the rotational speed of the motor 6 based on the amount (depth) of manipulation (pressing) of the trigger member 101, e.g., using a pulse width modulation technique. The motor-control part 17G outputs, based on the detection data from the rotation-detection devices of the sensor circuit board 61E, a drive instruction such that the motor 6 rotates at a target (desired) rotational speed, which is defined based on the amount of manipulation of the trigger member 101. When the motor-control part 17G has determined, based on a trigger signal acquired by the trigger-signal acquiring part 17A, that the manipulation of the trigger member 101 has been released, the motor-control part 17G outputs a stop instruction to stop the motor 6. For example, the stop instruction may include, e.g., simply stopping the supply of driving (energizing) currents to the coils 16D of the stator 61.

The torque-calculating part 17H calculates the torque that is momentarily being applied to the output shaft 8A. In order to perform this calculation, the torque-calculating part 17H can calculate the torque that is currently being output by the motor 6 based on the drive-current value (momentary drive-current value) supplied to the coils 61D and the rotational speed (momentary rotational speed) of the rotor 62 detected by the rotation-detection devices of the sensor circuit board 61E. This calculated motor torque is then multiplied by the currently-effective gear ratio of the speed-reducing mechanism 30. The currently-effective gear ratio can be determined based upon a signal output by the speed-mode determining part 17C based on a signal from the speed-manipulation state sensor 51, as was explained above. That is, when the speed-mode determining part 17C determines that the speed-reducing mechanism 30 is currently set to (operating in) the low-speed mode, the calculated motor torque is multiplied by the gear ratio of the speed-reducing mechanism 30 in the low-speed mode in order to calculate the spindle output torque (i.e. the torque momentarily being applied to the output shaft 8A and thus to the tool accessory that is rotationally driving, e.g., a screwdriver bit or a socket). On the other hand, when the speed-mode determining part 17C determines that the speed-reducing mechanism 30 is currently set to (operating in) the high-speed mode, the calculated motor torque is multiplied by the (lower) gear ratio of the speed-reducing mechanism 30 in the high-speed mode in order to calculate the spindle output torque (i.e. the torque momentarily being applied to the output shaft 8A).

Thus, in one or more embodiments of the present teachings, the amount of torque being applied by the stator 61 to the rotor 62 (i.e. the motor torque) can be estimated (calculated) by detecting (monitoring) the current value (in amperes) instantaneously being supplied to the coils 61D of the stator 61. Then, the torque being applied to the output shaft 8A (output torque) can be calculated by multiplying the estimated motor torque (input torque) by the gear ratio of the speed-reducing mechanism 30 (or, in the case of a multi-stage speed-reducing mechanism, by the effective gear ratio, which depends on the configuration of the multi-stage speed-reducing mechanism during the particular operation). In this regard, the output torque may be calculated based upon a single measured value, or based on a plurality of measured values. If a plurality of measured values is utilized in the calculation, then the measured values may be averaged or integrated over time, and the integrated or average value may be utilized. Preferably, the value utilized to determine the output torque, which is used for the purpose of determining when the currently-set torque threshold has been reached, is based upon measurements taken after an inrush current (i.e. a momentarily high current that typically results when the trigger switch 10A is initially squeezed or moved during operation) has subsided, which may be, e.g., 100-200 milliseconds after a change in the position of the trigger switch 10A is sensed.

In an exemplary embodiment for purposes of illustration of this concept, please assume that the (effective) gear ratio (mechanical advantage) of the speed-reducing mechanism 30 is (set to) 50. In this case, the output torque applied to the output shaft 8A via the chuck 62 will be 50 times greater than the input torque supplied by the rotor shaft 63. This also means that the rotor shaft 63 will be rotating 50 times faster than the chuck 82 (and thus the tool accessory as well).

Therefore, if the dial 16 has been rotated to set a torque threshold of 1 N·m (i.e. the currently-set torque threshold value, which is the upper limit of the torque that will be applied to the tool bit via the chuck), then the controller 17 can calculate the motor current value threshold that corresponds to 0.02 N·m applied to the rotor shaft 62. Thus, when the controller 17 detects that the instantaneous, average or integrated current value being supplied to the motor 6 corresponds to a motor torque output of 0.02 N·m, the controller 17 will stop the supply of current to the motor 6, thereby stopping the screwdriving operation without the need to use a mechanical clutch.

The controller 17 can calculate the threshold value of the current supplied to the motor in various ways.

For example, in one example, the motor output torque over a range of currents can be determined empirically by the manufacturer of the power tool. Then, a function or equation can be determined, such as f(A)=Tₘ, wherein A is the current in amperes and T. is the motor output torque (which will be the input torque to the speed-reducing mechanism 30). The output torque T_{O} of the speed-reducing mechanism 30 (which is applied to the spindle 91 and thus the output shaft 8A) can be obtained by multiplying the input torque (motor output torque Tₘ) by the (effective) gear ratio R (or mechanical advantage) of the speed-reducing mechanism 30 (i.e. which depends on whether the speed-reducing mechanism 30 is currently set to the high-speed mode or the low-speed mode), such that the equation or function is simply T_{O}=f(A)·R or T_{O}/R=f(A). This equation or function can then be stored in (programmed into) the controller 17 for use during operation of the power tool 1A according to the present teachings, such as the above-described hammer driver-drill.

Therefore, in such an embodiment, the controller 17 is adapted/configured (e.g., programmed) to calculate the currently-set current threshold A from the output torque T_{O}, which has been input by the user rotating the dial 16.

In another example, a lookup table (LUT) may be generated by the manufacturer of the power tool to provide a correspondence between a plurality of currently-set current thresholds A and currently-set output torques T_{O}. Then, the controller 17 need only access the LUT to identify the appropriate current threshold A for the currently-set torque threshold T_{O}.

If the speed-reducing mechanism 30 is a multi-stage gear transmission (such as in the first embodiment), then one LUT may be generated for each (effective) gear ratio of the multi-stage gear transmission. For example, a first LUT provides the relationships between output torque T_{O} and the motor current threshold A for the high-speed mode and a second LUT provides the relationships between output torque T_{O} and the motor current threshold A for the low-speed mode. In this example, the controller 17 may be configured to receive an input each time the user changes the configuration of the multi-stage gear transmission 30, e.g., by manually manipulating the speed change lever 12. Then, the controller 17 uses this input to select the LUT corresponding to the instantaneous (effective) gear ratio of the speed-changing mechanism 30 for the purpose of determining the appropriate electric current value threshold (in accordance with the present configuration of the multi-stage speed-reducing mechanism) for stopping the supply of current to the motor 6.

In summary, the “electronic clutch” of the present embodiment may be implemented, e.g., by a current sensor that determines the momentary current being supplied to the motor 6, a rotation speed sensor 61E for determining the momentary rotational speed of the rotor shaft (rotary shaft) 63 of the motor 6, a sensor 51 that determines whether the driver-drill is in the high-speed mode or the low-speed mode (which determines the gear ratio of the speed reducing mechanism 30) and the controller 17 that is programmed to calculate the momentary torque being applied to the output shaft 8A (and thus to the bit mounted in the chuck 82) based upon the momentary current, the momentary rotational speed and the current operating state (configuration) of the speed-reducing mechanism 30. In response to a determination that the momentary torque being applied to the output shaft 8A has reached the currently-set torque threshold (i.e. the maximum fastening torque or clutch-actuation torque), the controller 17 cuts off (interrupts) the supply of current to the motor 6, thereby stopping rotation of the motor 6.

Thus, in the present embodiment, when the spindle output torque calculated by the torque-calculating part 17H during the operation of the motor 6 exceeds the torque threshold set by the setting-instruction part 17F, the motor-control part 17G outputs a stop instruction to stop the motor 6, e.g., the supply of current to the motor is interrupted (stopped).

The display-control part 17I displays, on the display device 25, the drive condition of the motor 6, e.g., as a numerical value, based on the setting instruction that was output from the setting-instruction part 17F. In the present embodiment, the display-control part 17I displays, on the display device 25, the torque threshold set using the dial 16.

Operation of the Power Tool

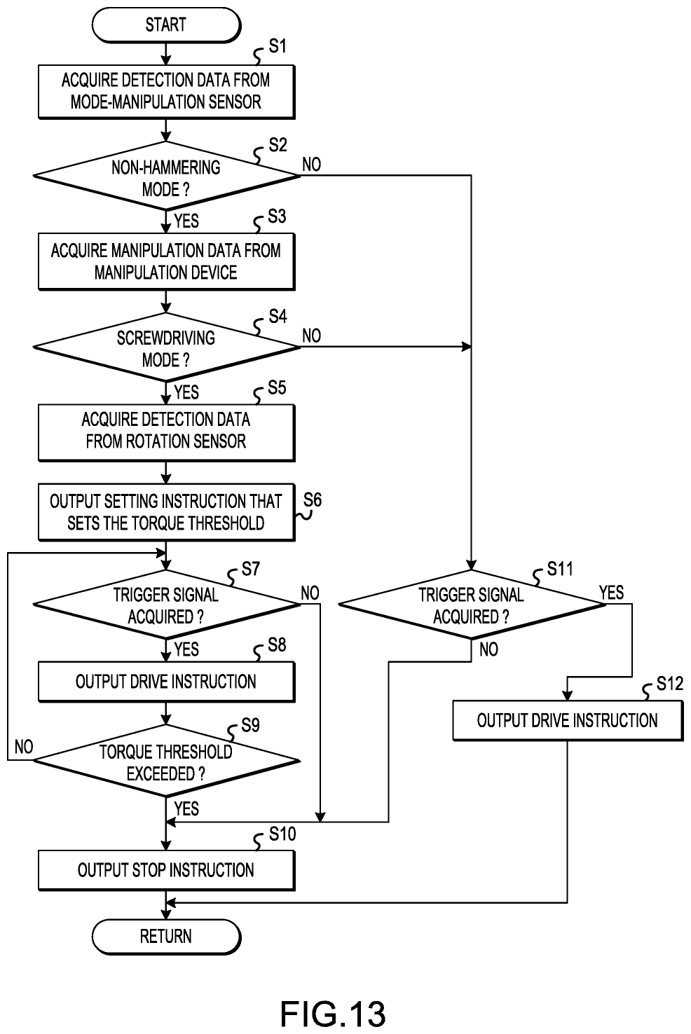

FIG. 13 is a flow chart that shows a representative method for operating of the power tool 1A according to the present embodiment. Specifically, in step S1, the action-mode determining part 17D acquires the detection data from the mode-manipulation-state sensor 53.

In step S2, the action-mode determining part 17D determines, based on the detection data from the mode-manipulation-state sensor 53 that was acquired in step S1, whether the action mode has been set to the non-hammering mode.

If the action mode is determined in step S2 to be set to the non-hammering mode (step S2: YES), then the process proceeds to step S3 and the manipulation-data acquiring part 17B acquires manipulation data from the manipulation device 24.

In the step S4, the manipulation-data acquiring part 17B determines, based on the manipulation data of the manipulation device 24 that was acquired in step S3, whether the action mode is set to the screwdriving mode.

If the action mode is determined in step S4 to be set to the screwdriving mode (step S4: YES), then the process proceeds to step S5

In step S5, the dial-data acquiring part 17E acquires the detection data from the rotation sensor 56. The dial-data acquiring part 17E then calculates, based on the detection data of the rotation sensor 56, the dial data, which includes the rotational direction and the rotational angle of the dial 16. This dial data is preferably converted into a numerical value (e.g., one of forty steps (an integer between 1 and 40), as was explained above) that is displayed on the display device 25 while the dial 16 is being manually rotated so that the user can visually confirm the torque threshold that is being set. Based on the dial data calculated in step S5, in step S6, the setting-instruction part 17F outputs to the motor-control part 17G a setting instruction that sets the torque threshold. As was noted above, this torque threshold is also preferably displayed on the display device 25.

In step S7, the motor-control part 17G determines whether or not the trigger-signal acquiring part 17A has acquired a trigger signal.

If it is determined in step S7 that a trigger signal has been acquired (step S7: Yes), then the motor-control part 17G outputs a drive instruction to drive the motor 6 in step S8. This drive instruction takes into account the amount of manipulation (depressing) of the trigger switch 10A to achieve the rotational speed desired by the user, i.e. the drive (energizing) currents are selected based on the amount of manipulation of the trigger switch 10A.

While the motor 6 is being driven, the torque-calculating part 17H continuously calculates the amount of torque that is currently (momentarily, instantaneously) being applied to the output shaft 8A (and thus to the tool accessory mounted in the chuck 82). In step S9, the motor-control part 17G determines whether the momentary amount of the spindle output torque exceeds the torque threshold that was set by the setting instruction, i.e. by the user rotating the dial 16 prior to initiating the fastening operation.

In step S9, if it is determined that the momentary amount of the spindle output torque does not exceed the torque threshold (step S9: NO), then the process returns to step S7 and the drive of the motor 6 is continued in accordance with the amount of manipulation of the trigger switch 10A.

On the other hand, if it is determined in step S9 that the momentary amount of spindle output torque exceeds the torque threshold (step S9: YES), then the motor-control part 17G outputs a stop instruction to stop the motor 6 in step S10, e.g., the supply of current to the motor 6 is stopped so that rotation of the rotor shaft 63 is stopped.

It is noted that, if it is determined in step S7 that a trigger signal has not been acquired (i.e. the user is not currently depressing the trigger switch 10A; step S7: No), then the process proceeds to step S10 and the motor-control part 17G does not drive (or stops driving) the motor 6.

Furthermore, if it is determined in step S4 that the action mode is not set to the screwdriving mode (step S5: NO), then the setting-instruction part 17F does not output a setting instruction and the process proceeds to step S11.

Similarly, if it is determined in step S2 that the action mode has not been set to the non-hammering mode (in other words, the action mode has been set to the hammering mode), then the process proceeds to step S11.

In step S11, the motor-control part 17G determines whether the trigger-signal acquiring part 17A has acquired a trigger signal.

In step S11, if it is determined that a trigger signal has been acquired (step S11: YES), then the motor-control part 17G outputs a drive instruction to drive the motor 6 in step S12. In this case, the motor 6 is driven in accordance with the amount of manipulation of the trigger switch 10A until the user releases the trigger switch 10A, which will cause rotation of the motor 6 to stop.

On the other hand, if it is determined in step S11 that a trigger signal has not been acquired (Step S11: NO), then the process proceeds to step S10 and the motor-control part 17G does not drive (or stops driving) the motor 6.

It is noted that, in the embodiments described above, it was decided that one of the drilling mode and the screwdriving mode is set in the non-hammering mode. However, in additional embodiments of the present teachings, one of the drilling mode and the screwdriving mode also may be set in the hammering mode. For example, if the screwdriving mode is set in the hammering mode and the momentary amount of spindle output torque is determined to exceed the torque threshold, then the motor-control part 17G may output a stop instruction to stop the motor 6.

### Effects

As explained above, in the above-described first embodiment, the dial 16 for setting the drive condition of the motor 6 is provided. The user can, by rotating the dial 16, finely set the drive condition (e.g., the threshold torque) of the motor 6 with good ease of operation.

The dial 16 is rotatable 360° or more in both the forward-rotational direction and the reverse-rotational direction. Thereby, the user can increment and decrement the torque threshold with good ease of operation and higher resolution than, e.g., a rotary potentiometer. The user can increment the torque threshold gradually or finely (stepwise) by rotating the dial 16 in the forward-rotational direction. The user can decrement the torque threshold gradually or finely (stepwise) by rotating the dial 16 in the reverse-rotational direction.

The permanent magnet 162, which rotates together with the dial 16, is provided. Thereby, by detecting the varying magnetic field of the rotating permanent magnet 162 relative to the rotation sensor 56, the rotation sensor 56 can detect the rotational direction and the rotational angle of the dial 16.

At least a portion of the dial 16 is disposed in the dial opening 28, which is formed in the housing 2. Thereby, at least a portion of the dial 16 is exposed to the exterior of the housing 2. Accordingly, the user can smoothly and easily manipulate the dial 16.

The dial 16 is disposed in a defined region of the housing 2 that differs from the grip part 22. Thereby, when the user grips the grip part 22 and performs work, the user's hand is restricted from touching the dial 16.

The dial 16 is disposed on the controller-housing part 23. Thereby, the distance between the rotation sensor 56 and the controller 17 is short. Accordingly, the detection data from the rotation sensor 56 is output to the controller 17 while minimizing the effects of noise.

Distance Da between the dial 16 and the controller 17 is shorter than distance Db between the trigger switch 10A and the controller 17. By disposing the dial 16 and the rotation sensor 56 in the vicinity of the controller 17 and not in the vicinity of the trigger switch 10A, the detection data from the rotation sensor 56 is output to the controller 17 while minimizing the effects of noise.

Distance Da between the dial 16 and the controller 17 is shorter than distance Dc between the motor 6 and the controller 17. By disposing the dial 16 and the rotation sensor 56 in the vicinity of the controller 17 and not in the vicinity of the motor 6, the detection data from the rotation sensor 56 is output to the controller 17 while reducing the effects of noise.

Distance Dd between the dial 16 and the output shaft 8A is longer than distance Dc between the motor 6 and the output shaft 8A. Because the dial 16 is not disposed in the vicinity of the output shaft 8A, the user can smoothly and easily manipulate the dial 16.

Rotational axis AX of the motor 6 and an axis parallel to dial axis DX are orthogonal. In the present embodiment, rotational axis AX extends in the front-rear direction, and dial axis DX extends in the left-right direction. Thereby, the user can smoothly manipulate the dial 16.

The drive condition (selected torque threshold, i.e. the maximum fastening torque to be applied in the fastening operation) of the motor 6 set using the dial 16 is displayed on the display device 25. Thereby, the user can visually confirm the drive condition of the motor 6 that is currently set.

The display device 25 is disposed at least partly surrounding (neighboring, adjacent) the dial 16. Thereby, the user can manipulate the dial 16 while conveniently visually confirming the information shown on the display device 25.

The manipulation device 24 is disposed at least partly surrounding (neighboring, adjacent) the dial 16. Thereby, the user can manipulate (press) the manipulation device 24 while conveniently visually confirming the information shown on the display device 25.

### Modified Examples of the First Embodiment

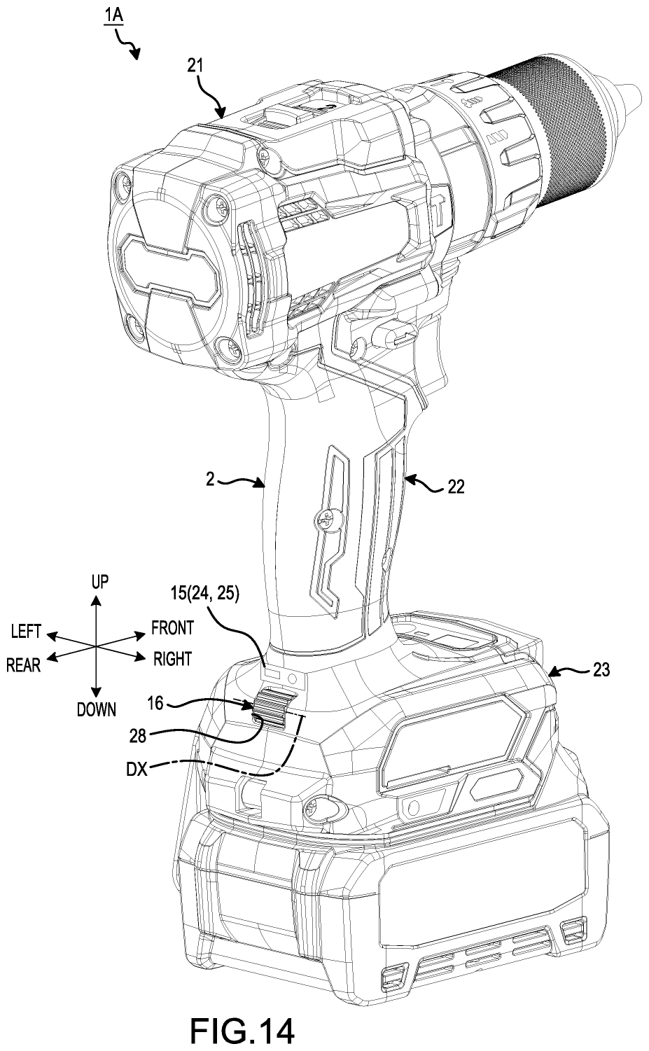

FIG. 14 is an oblique view, viewed from the rear, that shows the power tool 1A according to a modified example of the above-described first embodiment. As shown in FIG. 14, the dial 16 may be disposed on a rear portion of the controller-housing part 23. The dial opening 28 may be formed in the rear portion of the controller-housing part 23. In the example shown in FIG. 14, dial axis DX extends in the left-right direction. It is noted that dial axis DX may instead extend in the up-down direction. In addition, the interface panel 15, which includes at least one of the manipulation device 24 and the display device 25, may be disposed at least partly surrounding (neighboring, adjacent) the dial 16. In the example shown in FIG. 14, the interface panel 15 is disposed on the controller-housing part 23 upward of the dial 16. It is noted that the interface panel 15 may instead be disposed, on the controller-housing part 23, downward of the dial 16.

It is noted that the dial 16 may instead be disposed on a left portion of the controller-housing part 23 or may be disposed on the right portion of the controller-housing part 23. Dial axis DX may instead extend in the front-rear direction or may extend in the up-down direction.

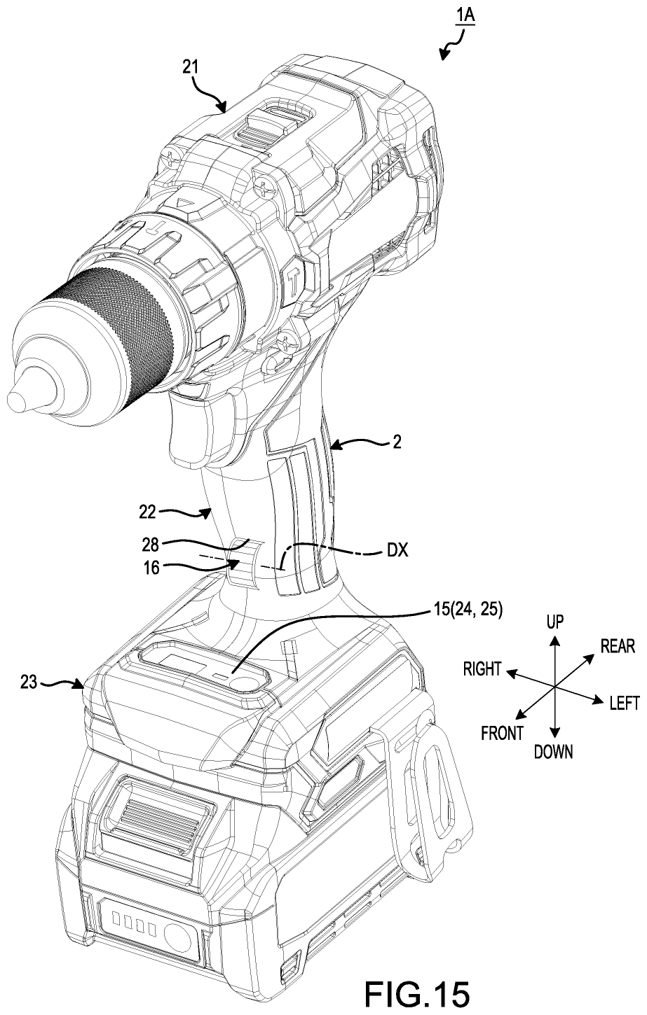

FIG. 15 is an oblique view, viewed from the front, that shows the power tool 1A according to another modified example of the above-described first embodiment. As shown in FIG. 15, the dial 16 may be disposed on the grip part 22. The dial opening 28 may be formed in the grip part 22. In the example shown in FIG. 15, the dial 16 is disposed on the front portion of the grip part 22. In the example shown in FIG. 15, dial axis DX extends in the left-right direction. It is noted, however, that dial axis DX may instead extend in the up-down direction.

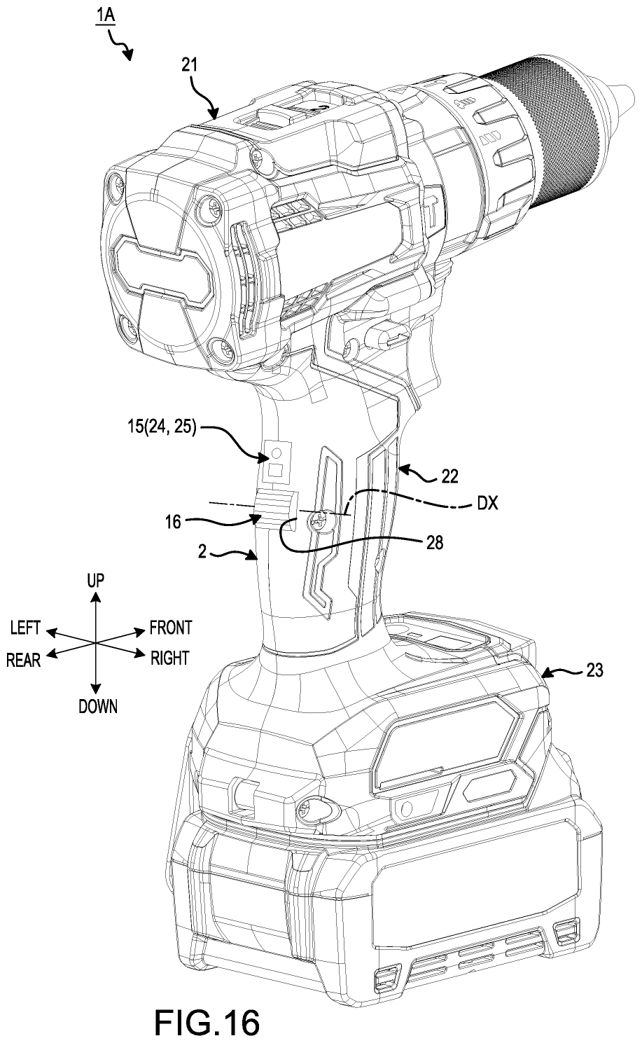

FIG. 16 is an oblique view, viewed from the rear, that shows the power tool 1A according to another modified example of the above-described first embodiment. As shown in FIG. 16, the dial 16 may be disposed on a rear portion of the grip part 22. In the example shown in FIG. 16, dial axis DX extends in the left-right direction. It is noted that dial axis DX may instead extend in the up-down direction. In addition, the interface panel 15, which includes at least one of the manipulation device 24 and the display device 25, may be disposed at least partly surrounding (neighboring, adjacent) the dial 16. In the example shown in FIG. 16, the interface panel 15 is disposed on the grip part 22 upward of the dial 16. It is noted, however, that the interface panel 15 may instead be disposed, on the grip part 22, downward of the dial 16.

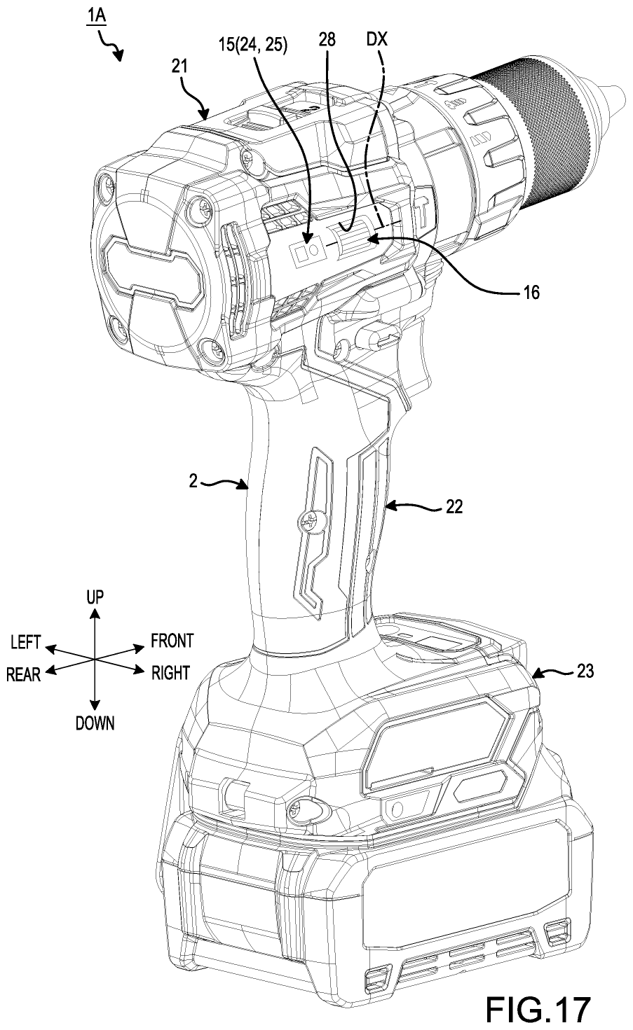

FIG. 17 is an oblique view, viewed from the rear, that shows the power tool 1A according to another modified example of the above-described first embodiment. As shown in FIG. 17, the dial 16 may be disposed on the motor-housing part 21. The dial opening 28 may be formed in the motor-housing part 21. In the example shown in FIG. 17, the dial 16 is disposed on a right portion of the motor-housing part 21 and dial axis DX extends in the front-rear direction. It is noted, however, that dial axis DX may instead extend in the up-down direction. In addition, the interface panel 15, which includes at least one of the manipulation device 24 and the display device 25, may be disposed at least partly surrounding (neighboring, adjacent) the dial 16. In the example shown in FIG. 17, the interface panel 15 is disposed on the motor-housing part 21 rearward of the dial 16. It is noted, however, that the interface panel 15 may instead be disposed, on the motor-housing part 21, forward of the dial 16.

It is further noted that the dial 16 may instead be disposed on a left portion of the motor-housing part 21 or may be disposed on the upper portion of the motor-housing part 21. The dial 16 may be disposed on the rear cover 3.

In the embodiments described above, the drive condition of the motor 6 set using the dial 16 may, instead of the torque threshold or in addition to the torque threshold, include the rotational speed of the motor 6. That is, by rotating the dial 16, the rotational speed of the motor 6 may be set. For example, the drive condition of the motor 6 set using the dial 16 may include an upper-limit (maximum) value of the rotational speed range of the motor 6. That is, by rotating the dial 16, the upper-limit value of the rotational speed of the motor 6 may be set. In known devices, the maximum (upper-limit) rotational speed of the output shaft 8A is set in the factory and is not changeable by the user. However, in either the high-speed mode or the low-speed mode of such a modified embodiment according to the present teachings, the user may set the maximum rotational speed of the output shaft 8A in one or both of the high-speed mode or the low-speed mode by setting the upper-limit value of the rotational speed of the motor 6. Furthermore, owing to the advantageous design of the dial 16 of the present teachings, the user can finely set the rotational speed of the motor 6 using the dial 16. The setting-instruction part 17F can then set the rotational speed (or maximum rotational speed) of the motor 6 in multiple steps (e.g., in 40 steps). When the dial 16 is rotated 45° in the forward-rotational direction, the rotational speed (e.g., the maximum rotational speed) of the motor 6 is incremented by one step. When the dial 16 is rotated 45° in the reverse-rotational direction, the rotational speed (e.g., the maximum rotational speed) of the motor 6 is decremented by one step. In the present (modified) embodiment as well, the dial 16 is rotatable 360° or more in both the forward-rotational direction and the reverse-rotational direction around dial axis DX. Consequently, the user can finely set the rotational speed (e.g., the maximum rotational speed) of the motor 6 in multiple steps by rotating the dial 16 by 45° per step in the forward-rotational direction or the reverse-rotational direction. In embodiments in which both the torque threshold and the rotational speed (e.g., the maximum rotational speed) of the motor are settable by the user, the controller 17 may be adapted/configured (programmed) to determine whether the torque threshold setting process or the rotational speed setting process is operational (enabled or disabled) based upon a signal output from the manipulation device 24. For example, by pressing the manipulation device 24, the controller 17 switches (cycles) among the torque threshold setting process and the rotational speed setting process. Optionally, the controller 17 may also switch (cycle) to a locked state, in which neither the torque threshold nor the rotational speed is settable (enabled) by the user.

### Second Embodiment

A second embodiment of the present teachings will now be explained. In the explanation below, structural elements that are identical or equivalent to those in the first embodiment (and modifications thereof) described above are assigned identical symbols, and explanations thereof are therefore abbreviated or omitted.

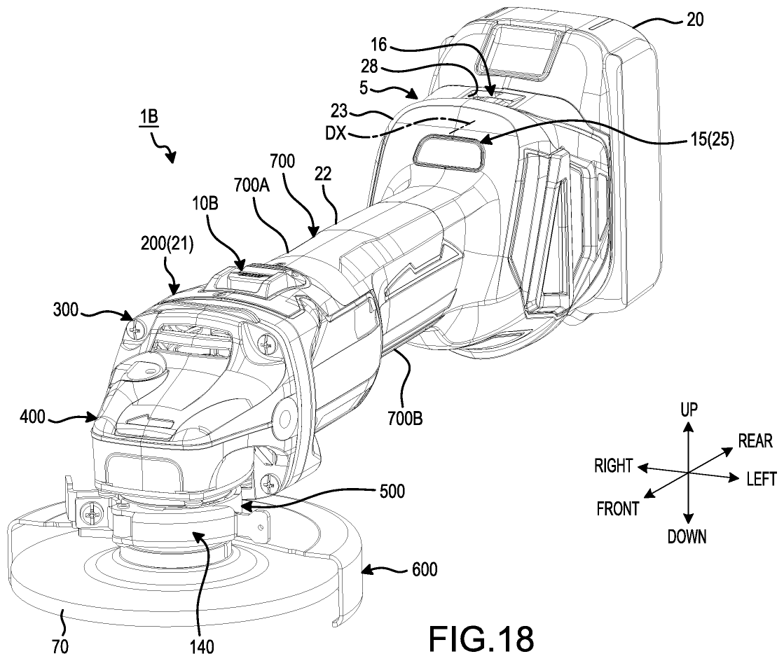

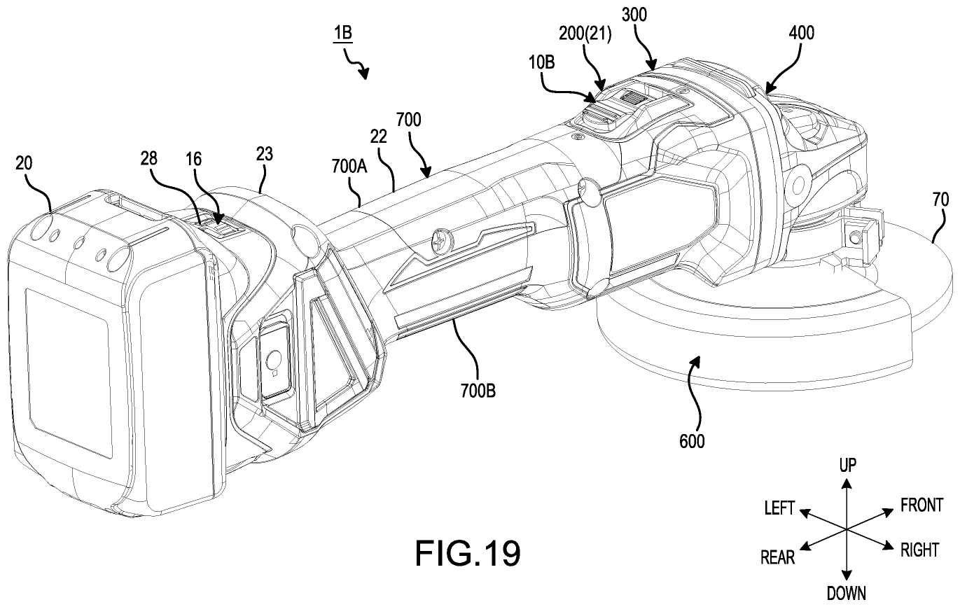

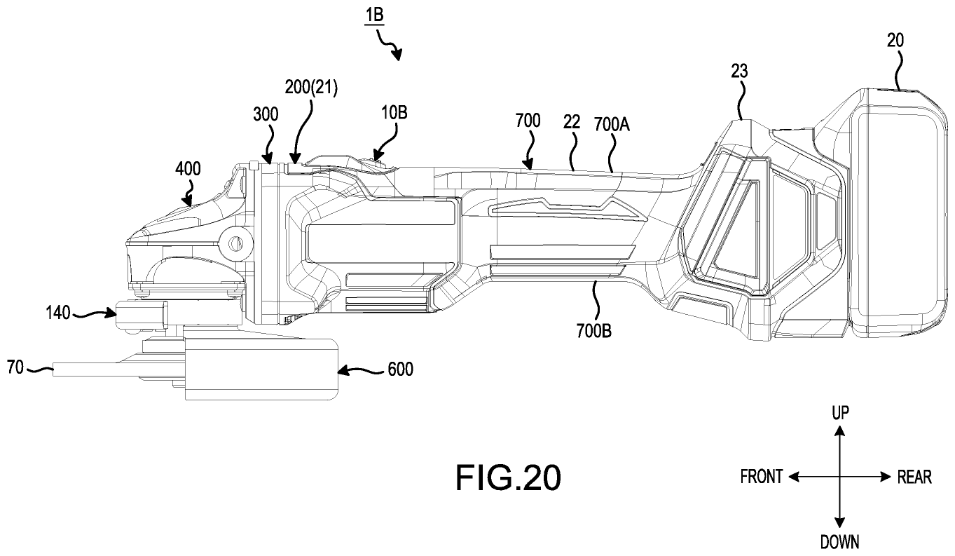

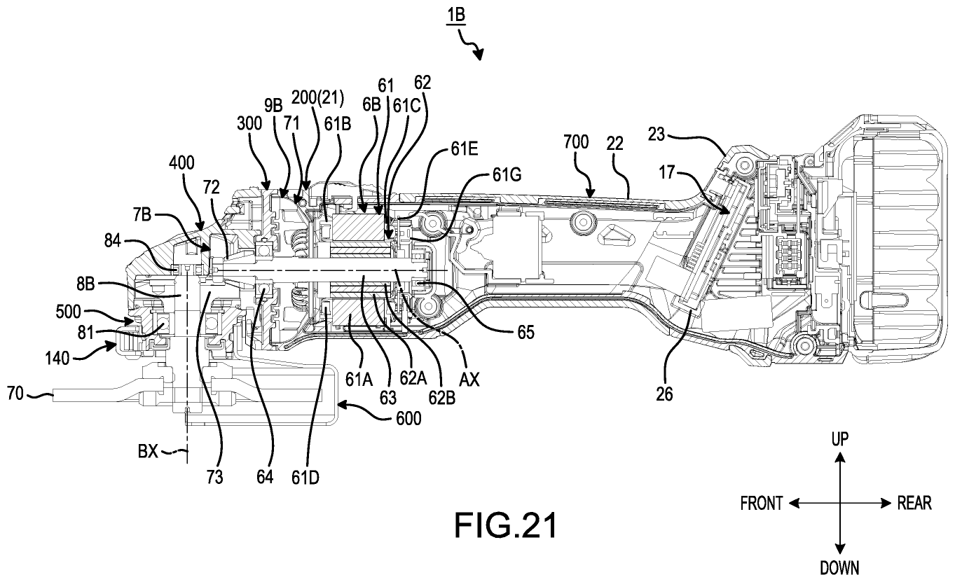

FIG. 18 is an oblique view, viewed from the front, that shows a power tool 1B according to the present (second) embodiment. FIG. 19 is an oblique view, viewed from the rear, that shows the power tool 1B according to the present embodiment. FIG. 20 is a side view that shows the power tool 1B according to the present embodiment. FIG. 21 is a cross-sectional view that shows the power tool 1B according to the present embodiment. In the present embodiment, the power tool 1B is a grinder.

As shown in FIGS. 18-21, the power tool 1B of the second embodiment comprises: a motor housing 200; a gear-housing cover 300, which is disposed forward of the motor housing 200; a gear housing 400, which is disposed forward of the gear-housing cover 300; a bearing box 500, which is disposed downward of the gear housing 400; a wheel cover 600, which is disposed downward of the bearing box 500; a grip housing 700, which is disposed rearward of the motor housing 200; and the battery-mounting part 5, which is disposed on a rear-end portion of the grip housing 700.

The motor housing 200 houses the motor 6 and has a tube shape. The motor housing 200 is made of synthetic resin, i.e. a polymer such as polyamide (nylon). The motor housing 200 functions as the motor-housing part 21.

The gear-housing cover 300 is disposed between the motor housing 200 and the gear housing 400. The gear-housing cover 300 is mounted on a front portion of the motor housing 200 such that it covers an opening in the front portion of the motor housing 200. The gear-housing cover 300 is made of metal, such as aluminum or an aluminum alloy.

The gear housing 400 houses at least a portion of an output shaft 8B. The output shaft 8B includes a spindle. In the present embodiment, the gear housing 400 houses an upper portion of the output shaft 8B. The gear housing 400 is mounted on the front portion of the motor housing 200 via the gear-housing cover 300. The gear housing 400 is made of metal, such as aluminum or aluminum alloy.

The bearing box 500 holds bearing 83 that rotatably supports the output shaft 8B. A tool accessory 70 is mounted on a lower-end portion of the output shaft 8B.

The wheel cover 600 is mounted on the bearing box 500 and is fixed to the bearing box 500 by a clamp mechanism 140. The wheel cover 600 is disposed partly surrounding the tool accessory 70. The tool accessory 70 has a disk shape and a grinding wheel is an illustrative example of the tool accessory 70. At least a portion of the wheel cover 600 is disposed rearward of the tool accessory 70.

The grip housing 700 is disposed on a rear portion of the motor housing 200. A front portion of the grip housing 700 is connected to the motor housing 200. The grip housing 700 comprises the grip part 22, which is configured to be gripped by the user, and the controller-housing part 23, which houses the controller 17. The controller-housing part 23 is disposed rearward of the grip part 22.

In the present embodiment, the grip housing 700 comprises an upper housing 700A and a lower housing 700B, which is disposed downward of the upper housing 700A. That is, the grip housing 700 is constituted by a pair of half housings.

As shown in FIG. 21, the power tool 1B comprises a motor 6B, a fan 9B, a baffle 71, a power-transmission mechanism 7B, and the output shaft 8B.

The motor housing 200 houses the motor 6B, the fan 9B, and the baffle 71. The gear housing 400 houses the power-transmission mechanism 7B. The gear housing 400 holds bearing 84 that rotatably supports the output shaft 8B. The bearing box 500 holds the bearing 83 that rotatably supports the output shaft 8B.

The output shaft 8B houses both the gear housing 400 and the bearing box 500. The gear housing 400 houses the upper portion of the output shaft 8B. The bearing box 500 houses a lower portion of the output shaft 8B.

The motor 6B is the source of motive power for the power tool 1B. The motor 6B is an inner-rotor-type brushless motor. The motor 6B comprises the stator 61 and the rotor 62. The rotor 62 comprises the rotor shaft 63.

The rotor 62 rotates around rotational axis AX. Rotational axis AX extends in the front-rear direction. The rotor 62 comprises the rotor shaft 63, the rotor core 62A, and the permanent magnets 62B. The rotor shaft 63 is rotatably supported by the bearing 64 and the bearing 65.

The stator 61 comprises the stator core 61A, the front insulator 61B, the rear insulator 61C, and the coils 61D. The sensor circuit board 61E and the short-circuiting member 61G are mounted on the rear insulator 61C.

The fan 9B rotates owing to the rotation of the rotor 62. The fan 9B is mounted on the front portion of the rotor shaft 63.

A switch 10B is provided on the motor housing 200. The switch 10B is manipulated (slid) to start the motor 6B. By sliding the switch 10B in the front-rear direction, the motor 6B is turned ON and OFF.

The power-transmission mechanism 7B transmits the power, which the motor 6B has generated, to the output shaft 8B. The power-transmission mechanism 7B comprises a first bevel gear 72, which is provided on the front-end portion of the rotor shaft 63, and a second bevel gear 73, which is provided on an upper-end portion of the spindle 81. The first bevel gear 72 and the second bevel gear 73 mesh with one another. Therefore, the output shaft 8B rotates when the rotor 62 rotates. More specifically, when the rotor shaft 63 of the rotor 62 rotates around rotational axis AX, the first bevel gear 72 rotates. When the first bevel gear 72 rotates, the second bevel gear 73 rotates. When the second bevel gear 73 rotates, the output shaft 8B rotates around rotational axis BX. Rotational axis BX extends in the up-down direction. Rotational axis AX and rotational axis BX are orthogonal to one another.

The output shaft 8B is rotatably supported by the bearing 83 and the bearing 84. The bearing 84 rotatably supports an upper portion of the spindle 81. The bearing 83 rotatably supports an intermediate portion or a lower portion of the spindle 81.

The tool accessory 70 is mounted on the lower-end portion of the output shaft 8B. When the output shaft 8B rotates, the tool accessory 70 rotates around rotational axis BX.

The power tool 1B comprises the dial 16 that is rotatable around dial axis DX. As shown in FIGS. 18 and 19, dial axis DX extends in the front-rear direction. At least a portion of the dial 16 is disposed in the dial opening 28, which is formed in the grip housing 700. In the present embodiment, the dial 16 is disposed on the motor-housing part 21.

The same as in the embodiment described above, the permanent magnet 162, which rotates together with the dial 16, is provided. The rotation of the dial 16 is detected by the rotation sensor 56.

As shown in FIG. 18, the interface panel 15, which comprises the display device 25, may be disposed in the vicinity of the dial 16, or even at least partially adjacent or neighboring (not shown) the dial 16.

The distance between the dial 16 and the controller 17 is shorter than the distance between the switch 10B and the controller 17. The distance between the dial 16 and controller 17 is shorter than the distance between the motor 6B and the controller 17. The distance between the dial 16 and the output shaft 8B is longer than the distance between the motor 6B and the output shaft 8B.

In the present embodiment, the drive condition of the motor 6B set using the dial 16 includes (is) the rotational speed (e.g., the maximum rotational speed) of the rotor shaft 63 of the motor 6B. That is, by rotating the dial 16, the rotational speed of the rotor shaft 63 of the motor 6B is set. More particularly, the rotational speed of the rotor shaft 63 of the motor 6B set in this embodiment is the upper-limit value of the rotational speed of the rotor shaft 63 of the motor 6B, because a grinder does not have a trigger switch for varying the rotational speed of the rotor shaft 63 of the motor 6B. Therefore, when the switch 10B is moved (slide) to the ON position, the rotor shaft 63 of the motor 6B will increase speed until reaching the set rotational speed and then maintain that rotational speed until the switch 10B is moved to the OFF position. In such an embodiment, the setting-instruction part 17F of the controller 17 outputs, based on the dial data that includes the detection data of (from, generated by) the rotation sensor 56, a setting instruction that sets the (maximum) rotational speed of the rotor shaft 63 of the motor 6B. The display-control part 17I can display, on the display device 25, the rotational speed of the rotor shaft 63 of the motor 6B that is currently set. In embodiments in which a speed-reducing mechanism (gear transmission) is operably coupled between the motor 6 and the output shaft 8A, the rotational speed of the output shaft 8A may be shown on the display device 25.

Owing to the design of the dial 16, the user can finely set the rotational speed of the rotor shaft 63 of the motor 6B using the dial 16. Similar to the first embodiment, the setting-instruction part 17F can set the rotational speed of the rotor shaft 63 of the motor 6B in multiple steps (e.g., in 40 steps). When the dial 16 is rotated 45° in the forward-rotational direction, the rotational speed of the rotor shaft 63 of the motor 6B is incremented by one step. When the dial 16 is rotated 45° in the reverse-rotational direction, the rotational speed of the rotor shaft 63 of the motor 6B is decremented by one step. In the present (second) embodiment, the dial 16 is rotatable 360° or more in both the forward-rotational direction and the reverse-rotational direction around dial axis DX. Consequently, the user can finely set the rotational speed of the rotor shaft 63 of the motor 6B (and thus of the output shaft 8A) in multiple steps by rotating the dial 16 by 45° per step in the forward-rotational direction or the reverse-rotational direction.

### Modified Examples of the Second Embodiment

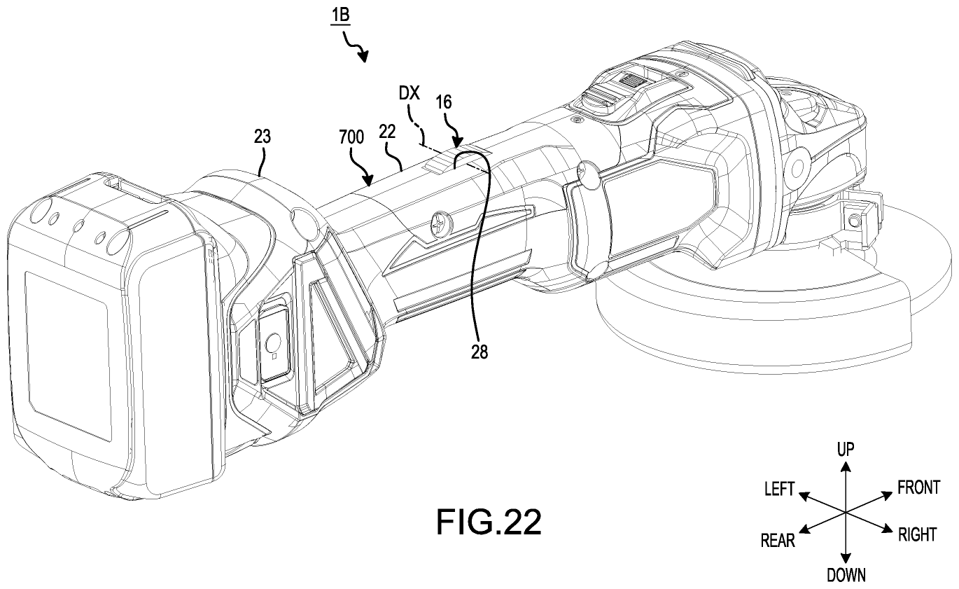

FIG. 22 is an oblique view, viewed from the rear, that shows the power tool 1B according to a modified example of the second embodiment. As shown in FIG. 22, the dial 16 may be disposed on the grip part 22, e.g., on the upper portion of the grip part 22. Dial axis DX extends in the left-right direction. It is noted, however, that dial axis DX may instead extend in the front-rear direction. Although not shown in FIG. 22, the interface panel 15 may be disposed in the vicinity of the dial 16, e.g., on the grip part 22.

It is further noted that the dial 16 may instead be disposed on a left portion of the grip part 22 or may be disposed on a right portion of the grip part 22.

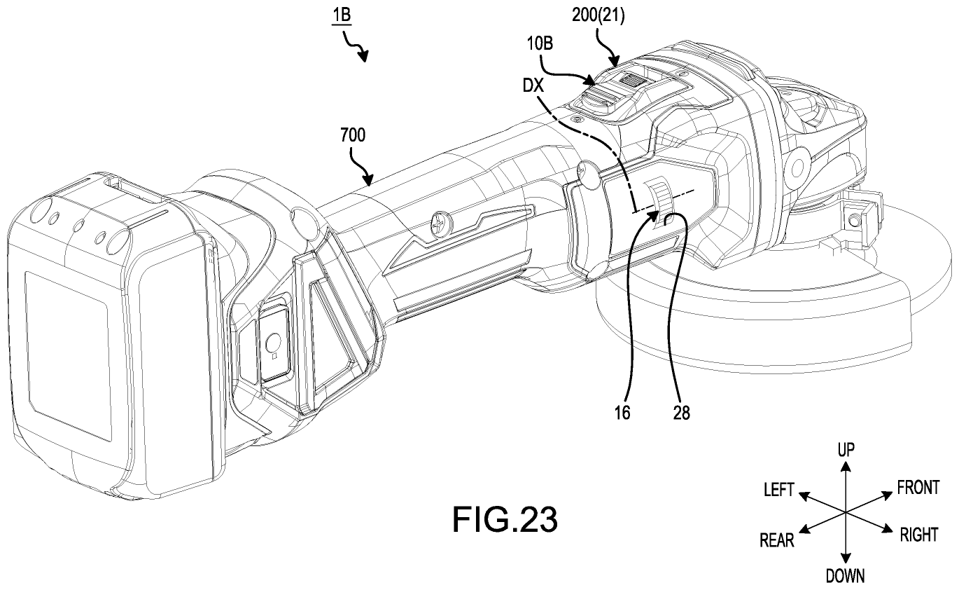

FIG. 23 is an oblique view, viewed from the rear, that shows the power tool 1B according to another modified example of the second embodiment. As shown in FIG. 23, the dial 16 may be disposed on the motor housing 200, which functions as the motor-housing part 21. In the example shown in FIG. 23, the dial 16 is disposed on a right portion of the motor housing 200 and dial axis DX extends in the front-rear direction. It is noted, however, that dial axis DX may instead extend in the up-down direction. Although not shown in FIG. 22, the interface panel 15 may be disposed at least partly surrounding (neighboring, adjacent) the dial 16, e.g., on the motor housing 200.

It is further noted that the dial 16 may instead be disposed on an upper portion of the motor housing 200 or may be disposed on the left portion of the motor housing 200.

### Third Embodiment

A third embodiment of the present teachings will now be explained. In the explanation below, structural elements that are identical or equivalent to those in the embodiments (or modifications thereof) described above are assigned identical symbols, and explanations thereof are therefore abbreviated or omitted.

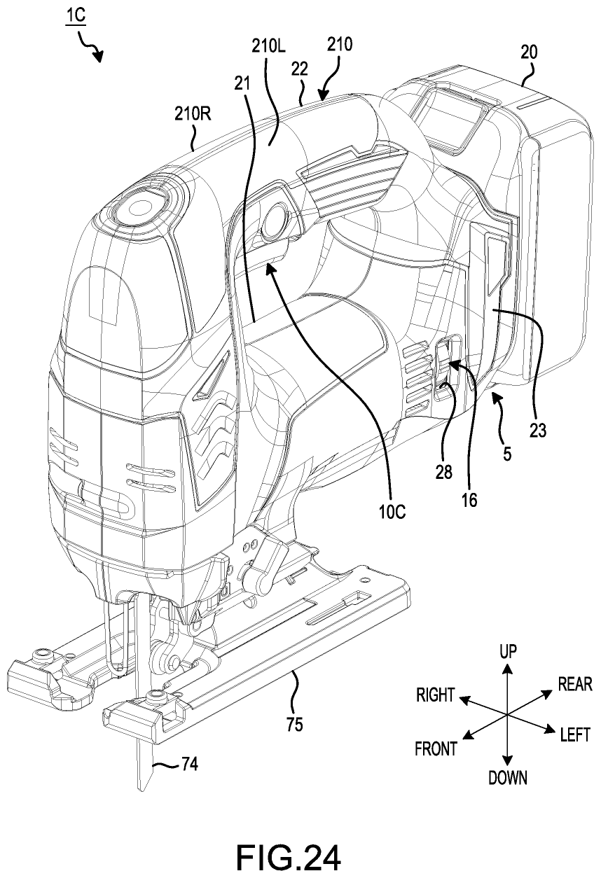

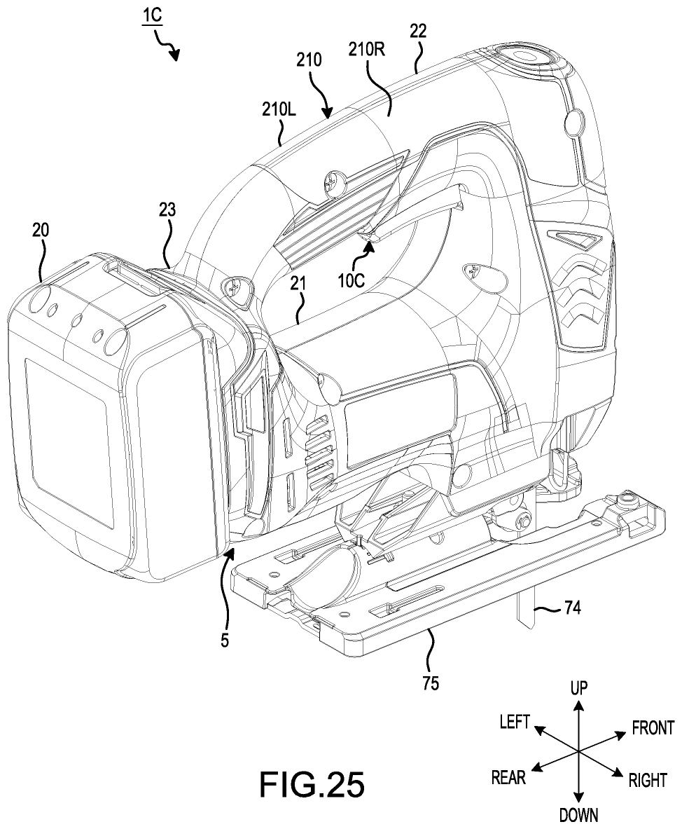

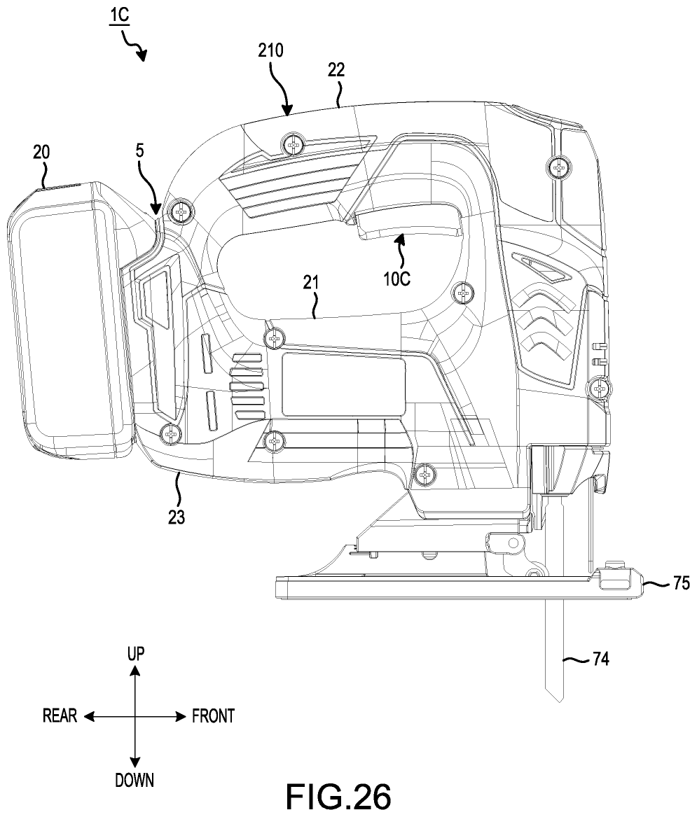

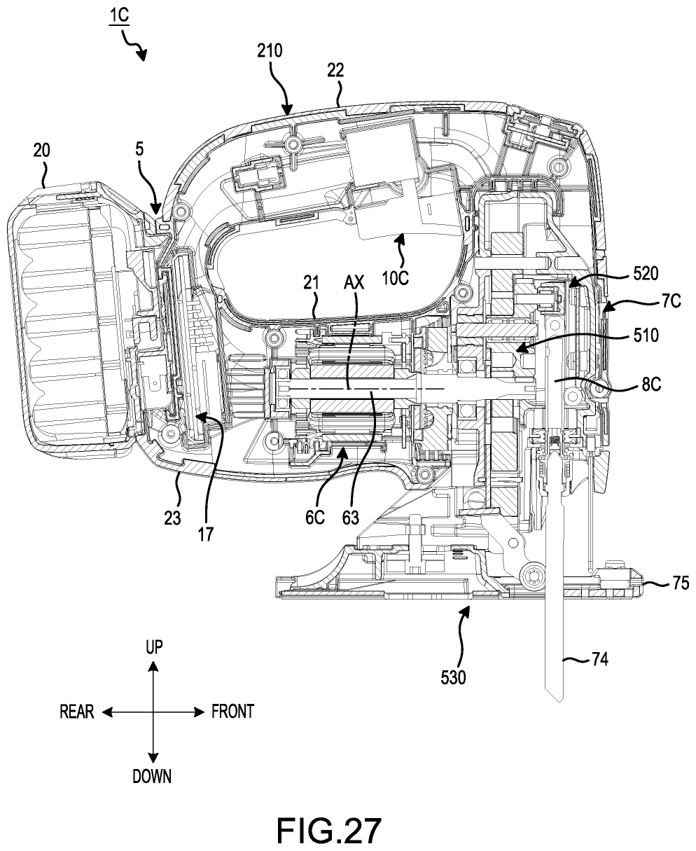

FIG. 24 is an oblique view, viewed from the front, that shows a power tool 1C according to the third embodiment. FIG. 25 is an oblique view, viewed from the rear, that shows the power tool 1C according to the present embodiment. FIG. 26 is a side view that shows the power tool 1C according to the present embodiment. FIG. 27 is a cross-sectional view that shows the power tool 1C according to the present embodiment. In the present (third) embodiment, the power tool 1C is a jigsaw.

As shown in FIGS. 24-27, the power tool 1C comprises a housing 210, the battery-mounting part 5, a motor 6C, a power-transmission mechanism 7C, an output shaft 8C, a switch 10C, the controller 17, and a base 75.

The housing 210 is made of synthetic resin, i.e. a rigid polymer, such as polyamide (nylon). The housing 210 comprises a left housing 210L and a right housing 210R. Thus, the housing 210 is constituted by a pair of half housings.

The housing 210 comprises: the motor-housing part 21, which houses the motor 6C; the grip part 22, on which the switch 10B is disposed; and the controller-housing part 23, which houses the controller 17. When the switch 10C is manipulated (depressed), the motor 6C starts. Rotational axis AX of the motor 6C extends in the front-rear direction.

The power-transmission mechanism 7C comprises an intermediate gear 510, a guide roller 520, and an orbital-motion mechanism 530. When the motor 6C generates the drive force and the rotor shaft 63 rotates, the intermediate gear 510 rotates. Owing to the rotation of the intermediate gear 510, the output shaft 8C moves up and down via the guide roller 520. The output shaft 8C includes a slider. A tool accessory 74, such as a jigsaw blade, is connected to a lower-end portion of the output shaft 8C.

The orbital-motion mechanism 530 pushes the tool accessory 74 forward when the tool accessory 74 rises and does not push the tool accessory 74 during the descent of the tool accessory 74, thereby causing the tool accessory 74 to undergo orbital motion.

The power tool 1C comprises the dial 16. At least a portion of the dial 16 is disposed in the dial opening 28, which is formed in the controller-housing part 23. In the present embodiment, the dial 16 is disposed on the motor-housing part 21.

The same as in the embodiments described above, the permanent magnet 162, which rotates together with the dial 16, is provided. The rotation of the dial 16 is again detected by the rotation sensor 56.

The distance between the dial 16 and the controller 17 is shorter than the distance between the switch 10C and the controller 17. The distance between the dial 16 and the controller 17 is shorter than the distance between the motor 6C and the controller 17. The distance between the dial 16 and the output shaft 8C is longer than the distance between the motor 6C and the output shaft 8C.

In the present (third) embodiment, the drive condition of the motor 6C set using the dial 16 is again the rotational speed (e.g., the maximum rotational speed) of the rotor shaft 63 of the motor 6C. That is, by rotating the dial 16, the rotational speed of the rotor shaft 63 of the motor 6C is set. More particularly, the rotational speed of the rotor shaft 63 of the motor 6C that is set may be the upper-limit value of the rotational speed range of the rotor shaft 63 of the motor 6C. The setting-instruction part 17F of the controller 17 outputs, based on the dial data that includes the detection data of (from, generated by) the rotation sensor 56, a setting instruction that sets the rotational speed of the rotor shaft 63 of the motor 6C. In the present embodiment, too, the user can finely set the rotational speed of the rotor shaft 63 of the motor 6C using the dial 16. Of course, the maximum up-down reciprocating speed of the tool accessory (jig saw blade) 74 corresponds to the maximum rotational speed of the rotor shaft 63 of the motor 6.

It is noted that, although not shown in FIGS. 24-27, the interface panel 15, which comprises the display device 25, may be disposed at least partly surrounding (neighboring, adjacent) the dial 16. In such an embodiment, the display-control part 17I can display, on the display device 25, the rotational speed of the motor 6C that is currently set.

### Modified Examples of the Third Embodiment

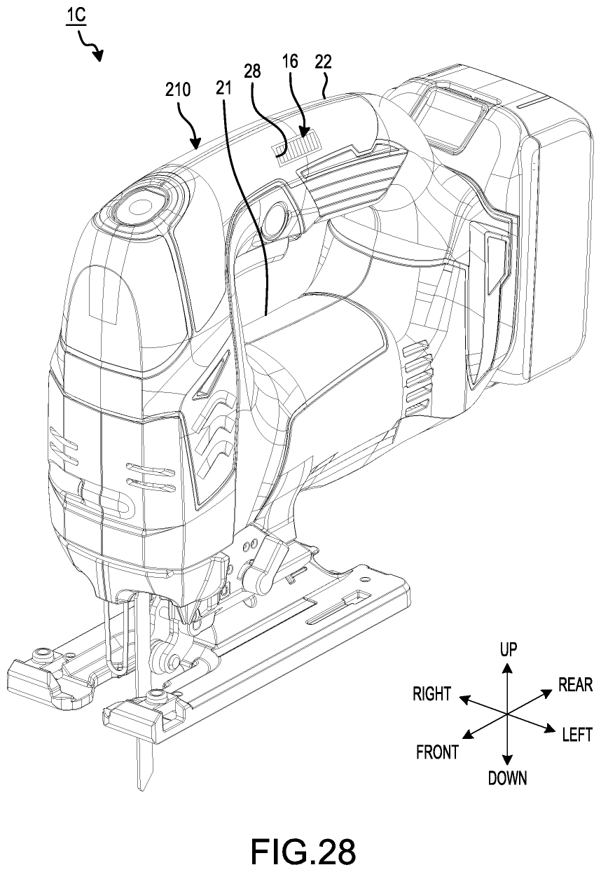

FIG. 28 is an oblique view, viewed from the front, that shows the power tool 1C according to a modified example of the third embodiment. As shown in FIG. 28, the dial 16 may be disposed on the grip part 22, e.g., on the left portion of the grip part 22. In addition, although not shown in FIG. 28, the interface panel 15 may be disposed at least partly surrounding the dial 16, e.g., on the grip part 22.

It is noted, however, that the dial 16 may instead be disposed on the upper portion of the grip part 22 or may be disposed on the right portion of the grip part 22.

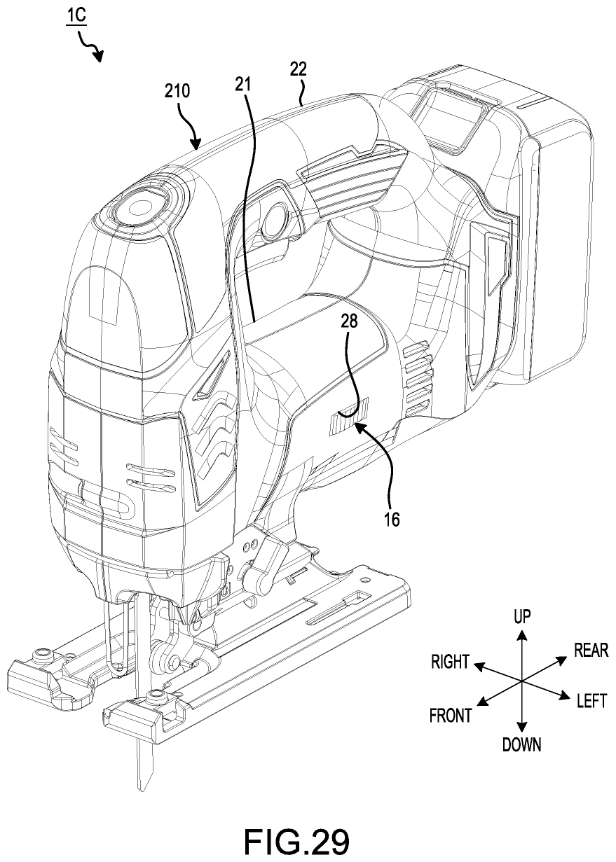

FIG. 29 is an oblique view, viewed from the front, that shows the power tool 1C according to another modified example of the third embodiment. As shown in FIG. 29, the dial 16 may be disposed on the motor-housing part 21, e.g., on the left portion of the motor-housing part 21. In addition, although not shown in FIG. 29, the interface panel 15 may be disposed at least partly surrounding the dial 16, e.g., on the motor-housing part 21.

It is further noted that the dial 16 may instead be disposed on the upper portion of the motor-housing part 21 or may be disposed on the right portion of the motor-housing part 21.

### Fourth Embodiment

A fourth embodiment of the present teachings will now be explained. In the explanation below, structural elements that are identical or equivalent to those in the embodiments (or modifications thereof) described above are assigned identical symbols, and explanations thereof are therefore abbreviated or omitted.

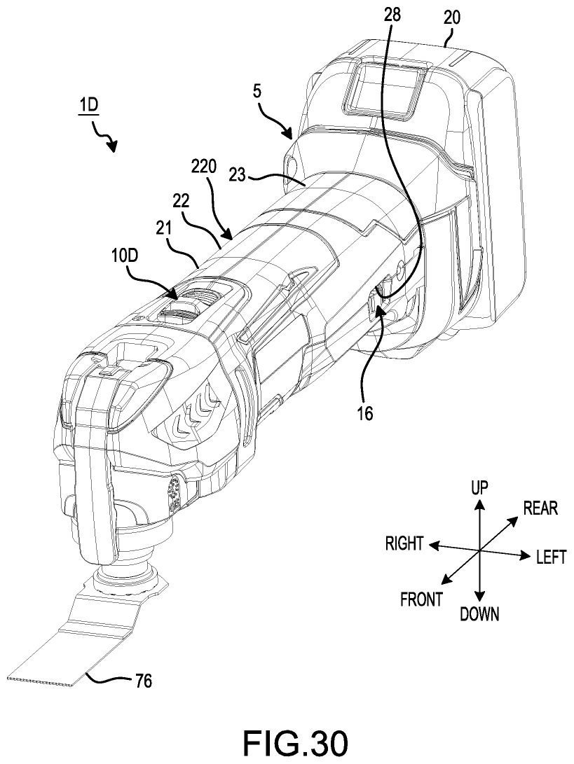

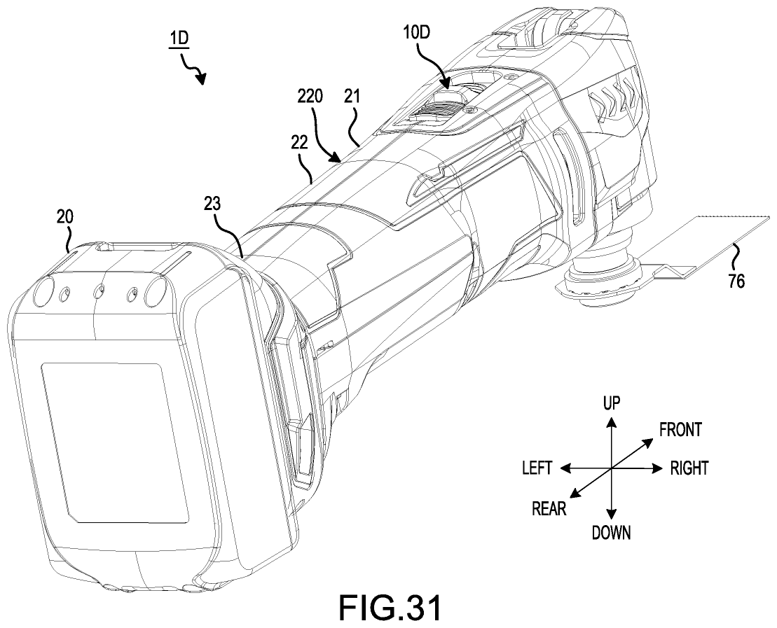

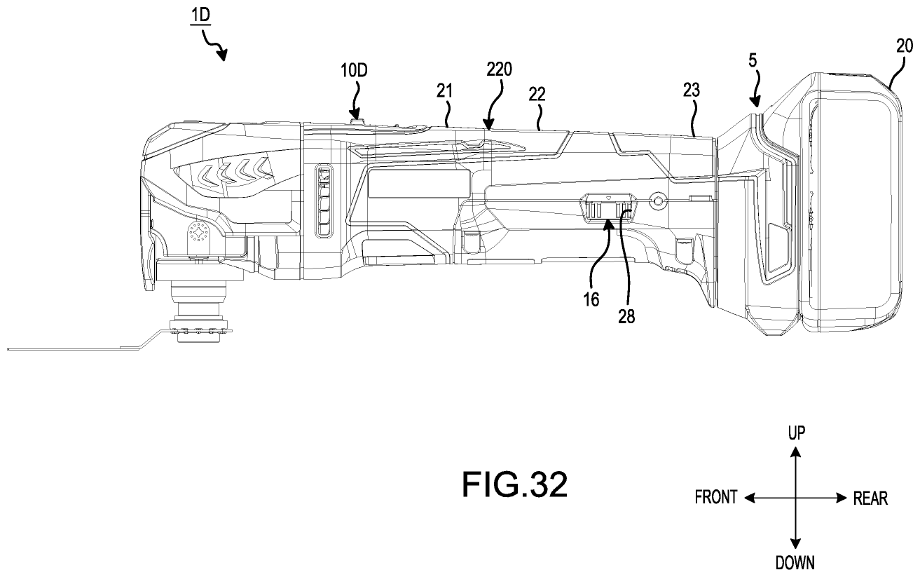

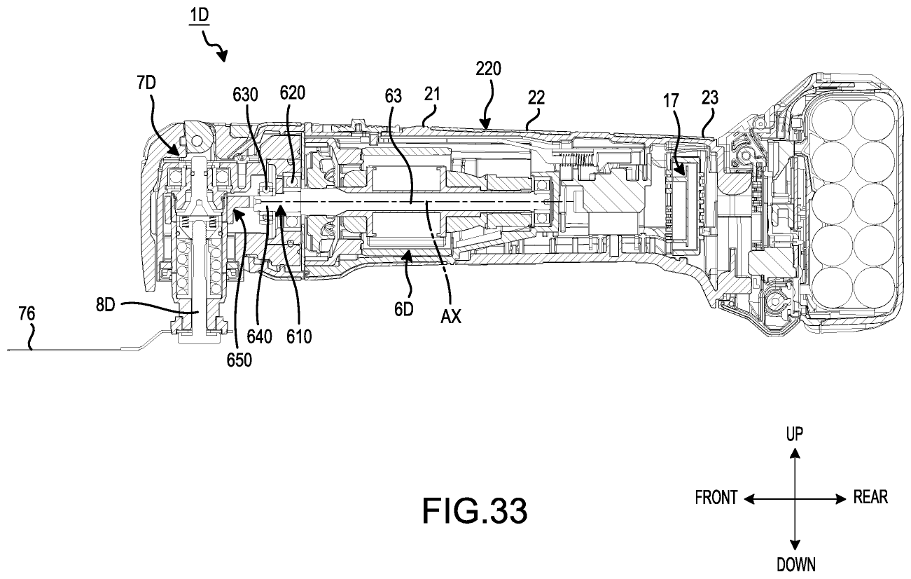

FIG. 30 is an oblique view, viewed from the front, that shows a power tool 1D according to the present (fourth) embodiment. FIG. 31 is an oblique view, viewed from the rear, that shows the power tool 1D according to the present embodiment. FIG. 32 is a side view that shows the power tool 1D according to the present embodiment. FIG. 33 is a cross-sectional view that shows the power tool 1D according to the present embodiment. In the present embodiment, the power tool 1D is a multi-tool, which is one type of a reciprocating-motion power tool.

As shown in FIGS. 30-33, the power tool 1D comprises a housing 220, the battery-mounting part 5, a motor 6D, a power-transmission mechanism 7D, an output shaft 8D, a switch 10D, and the controller 17.

The housing 220 is made of synthetic resin, i.e. a rigid polymer such as polyamide (nylon). The housing 220 comprises: the motor-housing part 21, which houses the motor 6D; the grip part 22, which is configured to be gripped by the user; and the controller-housing part 23, which houses the controller 17. When the switch 10D manipulated (slid in the front-rear direction), the motor 6D starts. Rotational axis AX of the motor 6D extends in the front-rear direction.

The power-transmission mechanism 7D comprises a shaft member 610, which is coupled to the front-end portion of the rotor shaft 63, and a link member 650. The shaft member 610 is rotatably supported by a bearing 620 and a bearing 630. The shaft member 610 comprises an eccentric-shaft part 640. The bearing 630 is disposed around the eccentric-shaft part 640.

The output shaft 8D includes a spindle and extends in the up-down direction. A tool accessory 76 is mounted on a lower-end portion of the output shaft 8D.

When the rotor shaft 63 rotates owing to the drive of the motor 6D, the bearing 630, which is disposed around the eccentric-shaft part 640, rotates eccentrically around the shaft member 610. By the repetitive performance of the movement in which the bearing 630 contacts the link member 650 only in the left-right direction, the link member 650 moves with reciprocating motion in the left-right direction. Thereby, the output shaft 8D and the tool accessory 76 move with reciprocating motion in the left-right direction.

The power tool 1D comprises the dial 16. At least a portion of the dial 16 is disposed in the dial opening 28, which is formed in the controller-housing part 23. In the present embodiment, the dial 16 is disposed on the motor-housing part 21.

The same as in the embodiments described above, the permanent magnet 162, which rotates together with the dial 16, is provided. The rotation of the dial 16 is detected by the rotation sensor 56.

The distance between the dial 16 and the controller 17 is shorter than the distance between the switch 10D and the controller 17. The distance between the dial 16 and the controller 17 is shorter than the distance between the motor 6D and the controller 17. The distance between the dial 16 and the output shaft 8D is longer than the distance between the motor 6D and the output shaft 8D.

In the present (fourth) embodiment, the drive condition of the motor 6D set using the dial 16 is again the rotational speed of the motor 6D. That is, by rotating the dial 16, the rotational speed (e.g., the maximum rotational speed) of the rotor shaft 63 of the motor 6D is set. More specifically, the rotational speed of the rotor shaft 63 of the motor 6D is the upper-limit value of the rotational speed range of the rotor shaft 63 of the motor 6D. The setting-instruction part 17F of the controller 17 outputs, based on the dial data that includes the detection data of (from, generated by) the rotation sensor 56, a setting instruction that sets the (maximum) rotational speed of the rotor shaft 63 of the motor 6D, which thereby determines the maximum reciprocating speed of the tool accessory 76. In the present embodiment, too, the user can finely set the rotational speed of the rotor shaft 63 of the motor 6D using the dial 16.

It is noted that, although not shown in FIGS. 30-33, the interface panel 15, which comprises the display device 25, may be disposed at least partly surrounding (neighboring, adjacent) the dial 16. In such an embodiment, the display-control part 17I can display, on the display device 25, the rotational speed of the motor 6D that is currently set.

### Modified Examples of the Fourth Embodiment

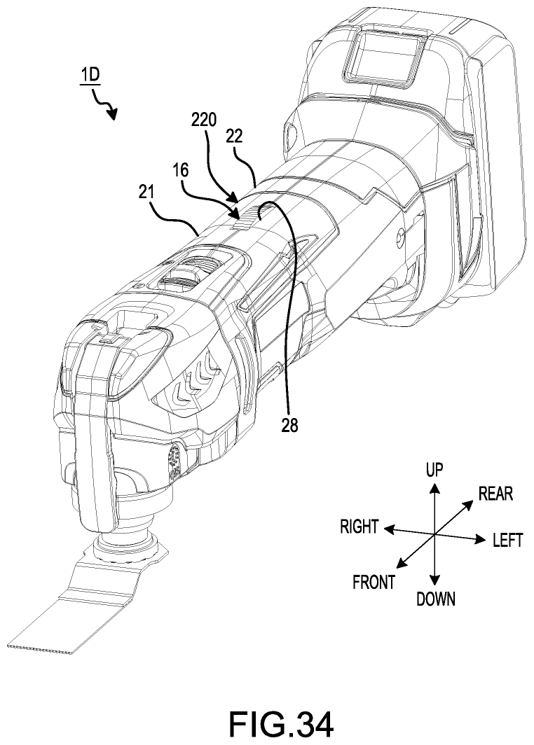

FIG. 34 is an oblique view, viewed from the front, that shows the power tool 1D according to a modified example of the fourth embodiment. As shown in FIG. 34, the dial 16 may be disposed on the grip part 22, e.g., on the upper portion of the grip part 22. In addition, although not shown in FIG. 34, the interface panel 15 may be disposed at least partly surrounding (neighboring, adjacent) the dial 16, e.g., on the grip part 22.

It is noted, however, that the dial 16 may instead be disposed on the left portion of the grip part 22 or may be disposed on the right portion of the grip part 22.

It is further noted that the dial 16 may instead be disposed on the motor-housing part 21, e.g., on at least a portion of the upper portion, the left portion, or the right portion of the motor-housing part 21. The interface panel 15 may be disposed, on the motor-housing part 21, at least partly surrounding the dial 16 in such a modified embodiment as well.

### Other Embodiments

It is noted that, in the embodiments described above, a hammer driver-drill, a grinder, a jigsaw, and a multi-tool were explained as representative, non-limiting examples of the power tool according to the present teachings. The power tool may be at least one of an angle drill, an impact driver, a grinder, a hammer, a hammer drill, a circular saw, and a reciprocating saw. If the dial 16 according to the present teachings is provided on these power tools, the drive condition(s) of the motor can be set with good ease of operation by manipulating the dial 16.

In the embodiments described above, although the electric work machine is a power tool, electric work machines according to the present teachings are not limited to power tools. For example, outdoor power equipment, such as gardening tools, are additional illustrative examples of an electric work machine of the present teachings. Without limitation, a chain saw, a hedge trimmer, a lawn mower, a brush cutter, and a blower are illustrative examples of such gardening tools.

In the embodiments described above, the battery pack 20, which is mounted on the battery-mounting part 5, is used as the power supply of the electric work machine. However, a commercial power supply (AC power supply) may instead be used as the power supply of the electric work machine.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved electric work machines, such as power tools and outdoor power equipment.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Although some aspects of the present disclosure have been described in the context of a device, it is to be understood that these aspects also represent a description of a corresponding method, so that each block or component of a device, such as the controller 17 and its various components 17A-17I, is also understood as a corresponding method step or as a feature of a method step. In an analogous manner, aspects which have been described in the context of or as a method step also represent a description of a corresponding block or detail or feature of a corresponding device, such as the control unit.

Depending on certain implementation requirements, exemplary embodiments of the controller 17 of the present disclosure may be implemented in hardware and/or in software. The implementation can be configured using a digital storage medium, for example one or more of a ROM, a PROM, an EPROM, an EEPROM or a flash memory, on which electronically readable control signals (program code) are stored, which interact or can interact with a programmable hardware component such that the respective method is performed.

A programmable hardware component can be formed by a processor, a computer processor (CPU=central processing unit), an application-specific integrated circuit (ASIC), an integrated circuit (IC), a computer, a system-on-a-chip (SOC), a programmable logic element, or a field programmable gate array (FGPA) including a microprocessor.

The digital storage medium can therefore be machine- or computer readable. Some exemplary embodiments thus comprise a data carrier or non-transient computer readable medium which includes electronically readable control signals which are capable of interacting with a programmable computer system or a programmable hardware component such that one of the methods described herein is performed. An exemplary embodiment is thus a data carrier (or a digital storage medium or a non-transient computer-readable medium) on which the program for performing one of the methods described herein is recorded.

In general, exemplary embodiments of the present disclosure, in particular the control unit, are implemented as a program, firmware, computer program, or computer program product including a program, or as data, wherein the program code or the data is operative to perform one of the methods if the program runs on a processor or a programmable hardware component. The program code or the data can for example also be stored on a machine-readable carrier or data carrier. The program code or the data can be, among other things, source code, machine code, bytecode or another intermediate code.

A program according to an exemplary embodiment can implement one of the methods during its performing, for example, such that the program reads storage locations or writes one or more data elements into these storage locations, wherein switching operations or other operations are induced in transistor structures, in amplifier structures, or in other electrical, optical, magnetic components, or components based on another functional principle. Correspondingly, data, values, sensor values, or other program information can be captured, determined, or measured by reading a storage location. By reading one or more storage locations, a program can therefore capture, determine or measure sizes, values, variable, and other information, as well as cause, induce, or perform an action by writing in one or more storage locations, as well as control other apparatuses, machines, and components.

Therefore, although some aspects of the controller 17 have been identified as “parts” or “steps”, it is understood that such parts or steps need not be physically separate or distinct electrical components, but rather may be different blocks of program code that are executed by the same hardware component, e.g., one or more microprocessors, and/or may be implemented using discrete hardware components.

1. An electric work machine comprising:

a motor;

an output shaft, which is driven based on (using) power generated by the motor;

a dial configured to be rotatable 360° or more, e.g., endlessly rotate, around a dial axis;

a rotation sensor configured to detect rotation of the dial; and

a controller;

wherein the controller is configured to generate a setting instruction that sets a drive condition of the motor, such as, e.g., a torque threshold (maximum fastening torque) and/or a rotational speed (e.g., a maximum rotational speed of a rotational speed range), based on detection data from the rotation sensor.

2. The electric work machine according to the above-embodiment 1, wherein the controller includes a non-transitory computer-readable medium comprising computer-readable instructions that are executable by at least one processor to cause at least one processor to generate the setting instruction that sets the drive condition of the motor, such as, e.g., the torque threshold (maximum fastening torque) and/or the rotational speed (e.g., the maximum rotational speed of the rotational speed range), based on the detection data from the rotation sensor.

3. The electric work machine according to the above-embodiment 1 or 2, wherein:

the dial is rotatable 360° or more around the dial axis in both a forward-rotational direction and a reverse-rotational direction;

the controller is configured (e.g., further comprises computer-readable instructions that are executable) to:
based on the detection data, calculate a rotational direction and a rotational angle of the dial; and
generate the setting instruction based on the calculated rotational direction and the calculated rotational angle.

4. The electric work machine according to any one of the above-embodiments 1-3, further comprising a magnet (preferably a permanent magnet, more preferably a hollow cylindrical permanent magnet) that rotates integrally with the dial, wherein the rotation sensor comprises a magnetic sensor configured to detect changes in a magnetic field of the magnet when the magnet rotates relative to the rotation sensor.

5. The electric work machine according to any one of the above-embodiments 1-4, further comprising a housing having a dial opening formed therein, at least a portion of the the dial being disposed in the dial opening.

6. The electric work machine according to the above-embodiment 5, wherein the housing comprises a controller-housing portion that houses the controller, the dial being disposed on the controller-housing portion.

7. The electric work machine according to the above-embodiment 5, wherein the housing comprises a motor-housing portion houses the motor, the dial being disposed on the motor-housing portion.

8. The electric work machine according to the above-embodiment 5, further comprising a switch configured to be manually manipulated to start the motor, wherein the housing comprises a grip portion (handle) and the switch and the dial are disposed on the grip portion.

9. The electric work machine according to the above-embodiment 5, further comprising a switch configured to be manually manipulated to start the motor, wherein the housing comprises a grip portion (handle), the switch is disposed on the grip portion and the dial is disposed in a defined region (separate portion) of the housing that differs from the grip portion.

10. The electric work machine according to the above-embodiment 8 or 9, wherein the distance between the dial and the controller is shorter than the distance between the switch and the controller.

11. The electric work machine according to any one of the above-embodiments 1-10, wherein the distance between the dial and the controller is shorter than the distance between the motor and the controller.

12. The electric work machine according to any one of the above-embodiments 1-11, wherein the distance between the dial and the output shaft is longer than the distance between the motor and the output shaft.

13. The electric work machine according to any one of the above-embodiments 1-12, wherein a rotational axis of the motor is orthogonal to a line that is parallel to the dial axis.

14. The electric work machine according to any one of the above-embodiments 1-13, further comprising a display device, wherein the controller is configured (e.g., further comprises computer-readable instructions that are executable) to cause the drive condition, which was set by the setting instruction, to be displayed on the display device.

15. The electric work machine according to the above-embodiment 15, wherein the display device is disposed at least partly surrounding, neighboring or adjacent to the dial.

16. The electric work machine according to any one of the above-embodiments 1-15, wherein the drive condition includes the rotational speed of the motor.

17. The electric work machine according to the above-embodiment 16, wherein the drive condition includes an upper-limit value of the rotational speed of the motor, e.g., a maximum rotational speed within a rotational speed range.

18. The electric work machine according to any one of the above-embodiments 1-17, wherein the drive condition includes the user-selected torque threshold (maximum fastening torque) and the controller is configured (e.g., further comprises computer-readable instructions that are executable) to output a stop instruction to stop the rotation of the motor when a torque that is currently acting on the output shaft during operation of the motor exceeds the user-selected torque threshold.

19. The electric work machine according to any one of the above-embodiments 1-17, further comprising a manipulation device, such as a button and/or switch, configured to be manually manipulated (e.g., pressed) to set a drive mode of the motor; wherein the controller is configured (e.g., further comprises computer-readable instructions that are executable) to acquire manipulation data from the manipulation device and generate the setting instruction in the drive mode, which was set using the manipulation device.

20. The electric work machine according to the above-embodiment 19, further comprising:

a hammer mechanism configured to cause the output shaft to hammer in an axial direction, e.g., to generate percussive impacts on the output shaft in the axial direction of the output shaft; and

a changing member, such as a rotatable ring, configured to switch an action mode of the hammer mechanism between a hammering mode, in which the output shaft is caused to hammer, and a non-hammering mode, in which the output shaft is not caused to hammer;

wherein:

the non-hammering mode includes a drilling mode, in which the motor generates the drive force regardless of the torque that is currently acting on the output shaft during operation of the motor, and a screwdriving mode, which stops the motor when the torque that is currently acting on the output shaft exceeds a torque threshold;

the drive mode includes the drilling mode and the screwdriving mode;

the drive condition includes the torque threshold; and

the controller is configured (e.g., further comprises computer-readable instructions that are executable) to generate and output the setting instruction in the screwdriving mode, which was set using the manipulation device.

21. The electric work machine according to any one of the above-embodiments 1-17, further comprising a manipulation device, such as a button and/or switch, configured to be manually manipulated (e.g., pressed) to enable the drive condition of the motor, such as, e.g., a torque threshold (maximum fastening torque) and/or a rotational speed (e.g., a maximum rotational speed of a rotational speed range) to be set; wherein the controller is configured (e.g., further comprises computer-readable instructions that are executable) to acquire manipulation data from the manipulation device and to enable the drive condition or disabled based on the operating state of the manipulation device.

22. The electric work machine according to the above-embodiment 21, further comprising:

a hammer mechanism configured to cause the output shaft to hammer in an axial direction, e.g., to generate percussive impacts on the output shaft in the axial direction of the output shaft; and

a changing member, such as a rotatable ring, configured to switch an action mode of the electric work machine among a hammering mode, in which the output shaft is caused to hammer, a drilling mode, in which the motor generates the drive force regardless of the torque that is currently acting on the output shaft during operation of the motor, and a screwdriving mode, which stops the motor when the torque that is currently acting on the output shaft exceeds a torque threshold;

the drive condition includes the torque threshold; and

the controller is configured (e.g., further comprises computer-readable instructions that are executable) to generate and output the setting instruction in the screwdriving mode, which was set using the manipulation device.

21. The electric work machine according to the above-embodiment 19 or 20, wherein the manipulation device is disposed at least partly surrounding, neighboring or adjacent the dial.

### EXPLANATION OF THE REFERENCE NUMBERS

1A Power tool
1B Power tool
1C Power tool
1D Power tool
2 Housing
2L Left housing
2R Right housing
2S Screw
3 Rear cover
3S Screw
4 Casing
4A First casing
4B Second casing
4S Screw
5 Battery-mounting part
6 Motor
6B Motor
6C Motor
6D Motor
7A Power-transmission mechanism
7B Power-transmission mechanism
7C Power-transmission mechanism
7D Power-transmission mechanism
8A Output shaft
8B Output shaft
8C Output shaft
8D Output shaft
9A Fan
9B Fan
10A Trigger switch
10B Switch
10C Switch
10D Switch
11 Forward/reverse change lever
12 Speed change lever
13 Mode-changing ring
14 Light
15 Interface panel
16 Dial
16A Cam projection
16B Projection part
16C Protruding part
16L Recess
16R Recess
16T Protruding part
17 Controller
17A Trigger-signal acquiring part
17B Manipulation-data acquiring part
17C Speed-mode determining part
17D Action-mode determining part
17E Dial-data acquiring part
17F Setting-instruction part
17G Motor-control part
17H Torque-calculating part
17I Display-control part
18 Air-suction port
19 Air-exhaust port
20 Battery pack
21 Motor-housing part
22 Grip part
23 Controller-housing part
24 Manipulation device
25 Display device
25A Segmented display device
25B Segment, light-emitting device
26 Controller case
27 Panel opening
28 Dial opening
30 Speed-reducing mechanism
31 First planetary-gear mechanism
31C First carrier
31P Planet gear
31R Internal gear
31S Pinion gear
32 Second planetary-gear mechanism
32C Second carrier
32P Planet gear
32R Internal gear
32S Sun gear
33 Third planetary-gear mechanism
33C Third carrier
33P Planet gear
33R Internal gear
33S Sun gear
34 Speed-changing ring
34T Protruding part
35 Coupling ring
36 Coil spring
40 Hammer mechanism
41 First cam
42 Second cam
43 Hammer changing ring
43S Opposing part
43T Projection part
44 Stop ring
45 Support ring
46 Steel ball
47 Washer
48 Cam ring
51 Speed-manipulation-state sensor
52 Permanent magnet
53 Mode-manipulation-state sensor
54 Mode-detection ring
55 Permanent magnet
56 Rotation sensor
61 Stator
61A Stator core
61B Front insulator
61C Rear insulator
61D Coil
61E Sensor circuit board
61F Fusing terminal
61G Short-circuiting member
62 Rotor
62A Rotor core
62B Permanent magnet
63 Rotor shaft
64 Bearing
65 Bearing
70 Tool accessory
71 Baffle
72 First bevel gear
73 Second bevel gear
74 Tool accessory
75 Base
76 Tool accessory
81 Spindle
81F Flange
82 Chuck
83 Bearing
84 Bearing
85 Lock cam
86 Lock ring
87 Coil spring
101 Trigger member
102 Switch circuit
140 Clamp mechanism
161 Rod
162 Permanent magnet
162N Notch
163 Cam
163A Cam projection
163T Protruding part
164 Coil spring
165 Center recess
166 Left recess
167 Right recess
168 Groove
169 Cover part
200 Motor housing
210 Housing
210L Left housing
210R Right housing
220 Housing
300 Gear-housing cover
400 Gear housing
401 Large-diameter part
402 Small-diameter part
403 Bracket plate
404 Stop plate
405 Screw
500 Bearing box
510 Intermediate gear
520 Guide roller
530 Orbital-motion mechanism
600 Wheel cover
610 Shaft member
620 Bearing
630 Bearing
640 Eccentric-shaft part
650 Link member
700 Grip housing
700A Upper housing
700B Lower housing
AX Rotational axis
BX Rotational axis
DX Dial axis

1. An electric work machine comprising:
a motor;
an output shaft operably coupled to and driven by the motor;
a dial configured to be rotatable 360° or more around a dial axis;
a rotation sensor configured to detect rotation of the dial; and
a controller;
wherein the controller comprises a setting-instruction part and/or stored instructions configured to output, based on detection data from the rotation sensor, a setting instruction that sets a drive condition of the motor.

2. The electric work machine according to claim 1, wherein:
the dial is rotatable 360° or more around the dial axis in both a forward-rotational direction and a reverse-rotational direction;
the controller includes a dial-data acquiring part and/or stored instructions configured to calculate, based on the detection data, a rotational direction and a rotational angle of the dial; and
the setting-instruction part is configured to output, based on the rotational direction and the rotational angle of the dial, the setting instruction.

3. The electric work machine according to claim 1, further comprising:
a magnet that rotates integrally with the dial;
wherein the rotation sensor comprises a magnetic sensor configured to detect varying magnetic fields of the magnet while the magnet rotates.

4. The electric work machine according to claim 1, further comprising:
a housing having a dial opening;
wherein at least a portion of the dial is disposed in the dial opening.

5. The electric work machine according to claim 4, wherein:
the housing comprises a controller-housing part that houses the controller; and
the dial is disposed on the controller-housing part.

6. The electric work machine according to claim 4, wherein:
the housing comprises a motor-housing part that houses the motor; and
the dial is disposed on the motor-housing part.

7. The electric work machine according to claim 4, further comprising:
a switch configured to be manipulated to start the motor;
wherein:
the housing comprises a grip part; and
the switch and the dial are disposed on the grip part.

8. The electric work machine according to claim 4, further comprising:
a switch configured to be manipulated to start the motor;
wherein:
the housing comprises a grip part;
the switch is disposed on the grip part; and
the dial is disposed in a defined region of the housing that differs from the grip part.

9. The electric work machine according to claim 8, wherein the distance between the dial and the controller is shorter than the distance between the switch and the controller.

10. The electric work machine according to claim 1, wherein the distance between the dial and the controller is shorter than the distance between the motor and the controller.

11. The electric work machine according to claim 1, wherein the distance between the dial and the output shaft is longer than the distance between the motor and the output shaft.

12. The electric work machine according to claim 1, wherein a rotational axis of the motor and an axis parallel to the dial axis are orthogonal to one another.

13. The electric work machine according to claim 1, further comprising:
a display device;
wherein the controller comprises a display-control part and/or stored instructions configured to cause the drive condition to be displayed on the display device based on the setting instruction output from the setting-instruction part.

14. The electric work machine according to claim 13, wherein the display device is disposed at least partly surrounding the dial.

15. The electric work machine according to claim 1, wherein the drive condition includes the rotational speed of the motor.

16. The electric work machine according to claim 15, wherein the drive condition includes an upper-limit value of the rotational speed of the motor.

17. The electric work machine according to claim 1, wherein:
the controller comprises a motor-control part configured to output a stop instruction to stop the motor in response to a determination that a momentary amount of torque that is currently being applied to the output shaft exceeds a torque threshold; and
the drive condition includes the torque threshold.

18. The electric work machine according to claim 1, further comprising:
a manipulation device configured to be manipulated to set a drive mode of the motor;
wherein:
the controller comprises a manipulation-data acquiring part and/or stored instructions configured to acquire manipulation data from the manipulation device; and
the setting-instruction part is configured to output the setting instruction in the drive mode, which was set using the manipulation device.

19. The electric work machine according to claim 18, further comprising:
a hammer mechanism configured to cause the output shaft to hammer in an axial direction; and
a mode-changing ring configured to switch an action mode of the hammer mechanism between a hammering mode, in which the output shaft is caused to hammer, and a non-hammering mode, in which the output shaft is not caused to hammer;
wherein:
the non-hammering mode includes a drilling mode, in which the motor generates the drive force regardless of a momentary amount of torque that is currently being applied to the output shaft during operation of the motor, and a screwdriving mode, in which the motor is stopped in response to a determination that the momentary amount of torque that is currently being applied to the output shaft exceeds a torque threshold;
the drive mode includes the drilling mode and the screwdriving mode;
the drive condition includes the torque threshold; and
the setting-instruction part is configured to output the setting instruction in the screwdriving mode.

20. The electric work machine according to claim 19, further comprising:
a magnet that rotates integrally with the dial; and
a display device;
wherein:
the manipulation device is disposed adjacent to the dial;
the dial is endlessly rotatable around the dial axis in both a forward-rotational direction and a reverse-rotational direction;
the rotation sensor comprises a magnetic sensor configured to detect varying magnetic fields of the magnet while the dial rotates;
the controller includes a dial-data acquiring part and/or stored instructions configured to calculate, based on the detection data from the magnetic sensor, a rotational direction and a rotational angle of the dial;
the setting-instruction part is configured to output, based on the rotational direction and the rotational angle of the dial, the setting instruction;
the controller comprises a display-control part and/or stored instructions configured to cause the drive condition to be displayed on the display device based on the setting instruction output from the setting-instruction part;
the distance between the dial and the controller is shorter than the distance between the motor and the controller; and
the distance between the dial and the output shaft is longer than the distance between the motor and the output shaft.
